(19) United States
(12) Patent Application Publication
(10) Pub. No.: US 2020/0223465 A1
(43) Pub. Date: Jul. 16, 2020

(54) COLLAPSIBLE LOCOMOTION PLATFORM AND CART

(71) Applicant: Yuval Geffen, Nir Banim (IL)

(72) Inventor: Yuval Geffen, Nir Banim (IL)

(21) Appl. No.: 15/754,876

(22) PCT Filed: Aug. 29, 2016
(86) PCT No.: PCT/IL2016/050944

§ 371 Date: Feb. 23, 2018

Related U.S. Application Data
(60) Provisional application No. 62/212,771, filed on Sep. 1, 2015.

(51) Int. Cl. B62B 3/02; B62B 5/00

(52) U.S. Cl. CPC B62B 3/027; B62B 3/008; B62B 5/0003

(57) ABSTRACT

A cart and a locomotion platform comprising a front wheel assembly and a rear wheel assembly, and a payload module articulated to said locomotion platform. The locomotion platform is manipulable between a maneuverable riding position at which the front wheel assembly and rear wheel assembly are deployed at an extended position, and a collapsed position, at which the front wheel assembly and the rear wheel assembly are collapsed, where the front wheel assembly and a rear wheel assembly are configured to automatically collapse upon encountering a barrier of a loading platform extending above the ground, and the front wheel assembly and the rear wheel assembly sequentially manipulate between their respective positions.

### TECHNOLOGICAL FIELD

The present disclosure is directed to a collapsible locomotion platform and collapsible wheel assemblies therefor. The disclosure is further directed to a cart comprising a payload module used in conjunction with such a locomotion platform.

### BACKGROUND ART

References considered to be relevant as background to the presently disclosed subject matter are listed below:
US2008093827
US2014140797
GB2471109
U.S. Pat. No. 6,045,150
US2008303248
U.S. Pat. No. 4,953,878

Acknowledgement of the above references herein is not to be inferred as meaning that these are in any way relevant to the patentability of the presently disclosed subject matter.

### BACKGROUND

US2008093827 discloses a shopping cart comprising; (a) a basket having an inside level and an outside level, said outside level being higher than said inside level, said basket further including first and second laterally spaced female track sections located on a bottom face of said basket; (b) a handle; (c) first and second pairs of vertical members extending downward from said basket, said first and second pairs of vertical members being laterally spaced from one another; (d) at least one wheel attached to at least one vertical member of each of said first and second pair of vertical members; both vertical members of said first vertical member pair each pivotably connected at respective lower ends to a first lateral side of a longitudinally extending frame; both vertical members of said second vertical member pair each pivotally connected at respective lower ends to a second lateral side of said longitudinally extended lower frame; both vertical members of said first vertical member pair each pivotally connected at respective upper ends to a first male track section; both vertical members of said second vertical member pair each pivotably connected at respective upper ends to a second male track section spaced laterally from said first male track section; said first and second male track sections adjacently slidably connected to said first and second laterally spaced female track sections, respectively, further forming a slidably retractable frame section; a lock and release mechanism attached to said bottom face of said basket, said mechanism selectively engaging said vertical members to lock said vertical members into a downwardly extending position, said mechanism selectively releasing said vertical members to allow said vertical members to be retracted; said vertical members, said male track sections and said longitudinally extending lower frame forming a rotationally retractable structure wherein said vertical members all simultaneously retract in a rotational direction towards said handle; said male track sections and said female track sections forming a slidably retractable structure wherein said vertical members, said male track sections and said longitudinally extending lower frame all simultaneously slide into a position under said basket.

US2014140797 discloses a vehicle storage device comprising: a) a trolley having folding legs with wheels which move from a first in use position with the legs supporting the trolley for wheeled movement along the ground, to a second storage position with the legs folded adjacent the trolley, said trolley providing storage for goods, and b) a housing for mounting in the vehicle to accommodate the trolley with legs in the second position, said housing being rotatable, in use the goods can be placed in the trolley in one location and the trolley can be used to transport the goods with its legs in the first position to the vehicle where the trolley legs can be placed in a second storage position and the trolley placed in the housing in the vehicle whilst still supporting said goods, said housing can be rotated in the vehicle to a preferred storage position, and the trolley can then be removed from the vehicle with its legs placed in the first position to transport goods to a second location

GB2471109 discloses a logistics system which enables the preloading of goods comprising at least one motor vehicle providing a transport volume adapted for carrying a separately displaceable transport container. At least a separately displaceable transport container having a dimension, shape and configuration adapted to perfectly fit in the transport volume provided by the motor vehicle. The transport container is equipped with an undercarriage having liftable and/or foldable legs and wheels or rollers bearing legs which are lifted and/or folded, when the transport container is stored within the transport volume on the load floor of the motor vehicle. Optionally the container has two or more boxes providing a modular configuration. The legs may be telescopic or pivotal and pairs of legs may be connected by a pivotal shaft or crossbar. Preferable the legs are lifted from their ground engaging position when the vehicle moves against them.

U.S. Pat. No. 6,045,150 discloses a collapsible utility cart for use with automobile trunks for allowing packages to be placed within the trunk of an automobile without having to lift the packages comprising, in combination:

a basket having a generally rectangular configuration, the basket having an open upper end and a closed bottom;

a pair of forward legs each having an upper end pivotally coupled with a forward portion of the closed bottom of the basket, each of the forward legs having a caster disposed on lower ends thereof, a cross bar extends between the forward legs disposed upwardly of the lower end, a U-shaped handle extends between the forward legs disposed downwardly of the upper ends, a pair of pivot brackets extend between the forward legs and the closed bottom of the basket, each of the forward legs having a supplemental support leg extending therethrough disposed above the lower ends whereby the supplemental support leg is orthogonally disposed with respect to the forward leg, the pair of forward legs having an extended orientation whereby they are perpendicular to the closed bottom of the basket and a collapsed orientation whereby they are folded upwardly to a position where a rearward extending portion of the supplemental support legs about the closed bottom of the basket; and a pair of rearward legs each having an upper segment and a lower segment, the upper segment having a length essentially equal to a height of the basket, a lower end of each upper segment pivotally coupled with an upper end of each lower segment, an upper end of each upper segment pivotally coupled with a rearward portion of the closed bottom of the basket, a lower end of each lower segment having a caster disposed thereon, the pair of rearward legs having an extended orientation whereby they are perpendicular to the closed bottom of the basket and a collapsed orientation whereby the upper segment is folded against a rear wall of the basket and the lower segment is folded within the open upper end of the basket.

US2008303248 discloses a portable shopping cart with foldable front legs and retractable back legs that permits the shoppers to easily unload the cart from the back of their Mini-van or SUVS and load it back to the vehicle, filled with groceries, with a minimum effort. The top part is a plastic rectangular basket or container with inside compartments that will permit the proper separation of different types of products so these will be well protected. It also includes some removable containers that fit in some of the compartments and are made of thermal materials to keep the dairy food and fresh food in good condition while is being transported. The basket is mounted on a metallic frame that holds the two sets of legs with wheels. The front of the basket is also equipped with a set of two wheels intended to hold the front of the cart and guide it inside the vehicle while the front legs are folded. The two front legs fold when the cart is pushed inside the vehicle and open when the cart is pulled out of the vehicle. The two back legs are telescopic designed to be retracted inside the basket when the cart is pushed in to the vehicle, and drop down when the cart is pulled out of the vehicle, by a spring mechanism.

U.S. Pat. No. 4,953,878 discloses a unitary collapsible cart comprising an upper body portion, a lower planar surface and legs for supporting said upper body portion; said upper body portion defining an upper compartment, said upper compartment having opposing side walls, foldable end walls hingedly secured to said side walls and a foldable bottom having a first and a second panel, each of said first and second panels hingedly attached to one of said side walls, and a third panel attached to each of said first and second panels in a hinged manner so that said bottom can be folded into a tri-fold shape, said legs being pivotably secured to said upper body portion to permit the folding of said legs to a position adjacent said upper body portion; said lower planar surface being removably secured to each of said legs and having at least two planar panels hingedly attached along a longitudinal axis; said legs and said cart being held in an unfolded, open position by said lower planar surface, removal of said lower planar surface permits the cart to be collapsed into a compact rectangular shape.

### GENERAL DESCRIPTION

According to one aspect of the disclosure there is a locomotion platform comprising a front wheel assembly and a rear wheel assembly, and a payload module articulated to said locomotion platform, said locomotion platform is manipulable between a maneuverable riding position at which said front wheel assembly and rear wheel assembly are deployed at an extended position, and a collapsed position, at which the front wheel assembly and the rear wheel assembly are collapsed.

The term ‘payload module’ as used herein denotes any assembly, fixedly or detachably articulated to a locomotion platform of the present disclosure, such as, a basket, bucket, tool cart, shopping cart, hand cart, stretcher, seat, and the like. A payload can also be a load mounted directly or indirectly over the locomotion platform (e.g. different cargo, bags, articles, etc.)

According to another aspect of the disclosure there is a cart comprising a locomotion platform comprising a front wheel assembly and a rear wheel assembly, and a payload module fixedly or detachably articulated to said locomotion platform, said locomotion platform is manipulable between a maneuverable riding position at which said front wheel assembly and rear wheel assembly are deployed at an extended position, and a collapsed position, at which the front wheel assembly and the rear wheel assembly are collapsed.

Yet an aspect of the disclosure is directed to a payload module fixedly or detachably articulated to a locomotion platform, said locomotion platform comprising a front wheel assembly and a rear wheel assembly, and being manipulable between a maneuverable riding position at which said front wheel assembly and rear wheel assembly are deployed at an extended position, and a collapsed position, at which the front wheel assembly and the rear wheel assembly are collapsed.

Another aspect of the disclosure is concerned with a front wheel assembly and a rear wheel assembly, for use in conjunction with a locomotion platform of a cart, at least one of which being manipulable between a maneuverable riding position at which said front wheel assembly and rear wheel assembly are deployed at an extended position, and a collapsed position, at which the front wheel assembly and the rear wheel assembly are collapsed. The front wheel assembly and the rear wheel assembly can be similar or even identical mechanisms, or different.

According to a particular embodiment, the disclosure is direct to a cart wherein the front wheel assembly and a rear wheel assembly of the locomotion platform are configured to collapse upon encountering an edge of a loading platform extending above the ground.

According to an example of the disclosure, the front wheel assembly and a rear wheel assembly automatically collapse upon encountering a rear portion of a vehicle cargo space, facilitating accommodating the cart within the cargo area/space of the vehicle. The effort required for collapsing the wheel assemblies is minimal, regardless the weight born thereby, i.e. manipulating the cart into the collapsed position does not require overcoming the load born thereby, but rather requires pushing the cart.

The term automatically as used in connection with collapsing and deploying the locomotion platform and cart, respectively, as used herein denotes that the front wheel assembly and the rear wheel assembly are configured for collapsing from their riding position into their respective collapsed position upon encountering a barrier disposed at a predetermined height range, wherein the force required for collapsing the front wheel assembly and the rear wheel assembly is transformed from a force acting in a direction progressing the cart against said loading platform. Likewise, the front wheel assembly and the rear wheel assembly are configured for deploying into their respective extended position upon displacing from an elevated platform. The front wheel assembly and the rear wheel assembly will not collapse upon encountering an obstacle disposed over the ground or at an elevation which substantially exceeds the predetermined height range. The term barrier as used herein denotes any object extending at a predetermined elevation range, above the ground, and configured with an edge or an encountering portion, so that when an activating mechanism of the locomotion platform encounters said barrier it causes the respective wheel assembly to collapse.

It is appreciated that whilst the front wheel assembly and the rear wheel assembly are automatically displaceable between their respective riding position and collapsed position, there can be associated safety or locking arrangements requiring interference to facilitate such displacement, respectively.

The term vehicle as used herein in the specification and claims denotes any type of vehicle configured with a cargo area (at times referred to as trunk, storage space, rear bed, etc.), with or without a rear door, of any type. A vehicle suitable for use in conjunction with the cart of the present disclosure is typically similar to a station wagon, estate car, SUV/CUV, pickup car/trunk, or a van, i.e. vehicles typically having relatively a large carrying space. However, it is appreciated that the term vehicle can be extrapolated to denote a ramp, platform, stage, etc.

The term cart as used herein in the specification and claims denotes any sort of cart, however configured with a storage area mounted over the aforementioned locomotion platform. The cart can be, for example, a shopping cart, a tool box and storage caddy recreation/sport gear carrier, a pet carrier, etc. Likewise, the cart can be used for locomoting a load mounted directly or indirectly over the locomotion platform (e.g. different cargo, bags, articles, etc.).

According to the disclosure there is a cart configured with a payload module mounted over a locomotion platform, wherein the locomotion platform is configured for riding over a surface at the normal course of use, and however is readily collapsible upon introducing into a storage space of a vehicle, wherein the locomotion platform collapses in two main steps so that a rear support collapses at last, upon introducing at least a major portion of the cart into the storage space, and further wherein collapsing of the locomotion platform is triggered upon an activating mechanism encountering a portion of the storage space. The locomotion platform is also configured for automatically displacing into its extended, operative position, upon retraction from the storage space.

Yet an aspect of the present disclosure is directed to the front wheel assembly comprising a uniform arm articulated to a break-link mechanism (collapsing link mechanism) associated with the front activating mechanism, said break-link mechanism comprising a first link articulated at one end thereof to the base frame and pivotally linked to a second link which in turn is articulated at an end thereof to a wheel arm fitted at a bottom end with a caster, whereby the at an extended (riding position), the first link and the second link are geometrically locked at coextensive position. The first link is further configured with a lever articulated with the front activating mechanism, whereupon pivotal displacement of the activating mechanism entails corresponding pivotal displacement of the first link, resulting in collapsing of the link mechanism with corresponding swinging of the wheel arm into its collapsed position.

The rear wheel assembly comprises a parallel link mechanism comprising a wheel arm having a top arm link pivotally articulated at one end to the base frame of the locomotion platform and pivotally coupled at its opposed end to a bottom arm link fitted at its bottom end with a caster; and a parallel link having a first end pivotally secured to the base frame and a second end pivotally articulated to the second arm link, below the pivoting point of the top arm link, wherein said parallel link remains parallely disposed with respect to the top arm link.

Any one or more of the following features, design and configurations can be applied to any one or more of the aspects of the present disclosure, separately or in various combinations:
The payload module can be detachably attachable to a base frame of the locomotion platform;
The payload module can be collapsible, whereby side walls of the thereof are foldable;
The payload module can be configured with a base, and at least two substantially upright side walls extending therefrom;
The payload module can be configured with a child seat;
The payload module can be compartmented by partition walls; said partition walls can be modular and can be dispositioned or removed all together;
The payload module can comprise a maneuvering (push/pull) handle;
The maneuvering handle can be adjusted and collapsible so as to reduce the overall size of the cart, at its collapsed position;
Some or all of the walls of the payload module can be made of any suitable material, e.g. plastic material, or metal, etc.;
Some or all of the walls of the payload module can be in the form of a grid;
The cart can be configured with an arresting mechanism for securing to a loading surface within a carrying space of the vehicle;
The locomotion platform can be operable in conjunction with a platform or rail set articulated within the storage space of the vehicle;
The locomotion platform can be configured with a locking mechanism to prevent unauthorized utilization thereof;
The locomotion platform can be configured with a front wheel assembly and a rear wheel assembly, each comprising a pair of arms each disposed at a respective side of the locomotion platform and configured at their free end with a caster; each of the arms of the front wheel assembly and the rear wheel assembly is manipulable between a riding position at which the arms are locked out at an extended position, and a collapsed position at which the arms are collapsed and retracted, disposed adjacent a rear edge of the locomotion platform; and wherein at the riding position the casters are substantially equi-leveled and configured for rolling over a surface;
At a particular collapsed configuration, the casters can be substantially equi-leveled and configured for rolling over a surface;
The arms of the front wheel assembly and the rear wheel assembly are displaceable in parallel to one another;
The two arms of the front wheel assembly and the rear wheel assembly can be articulated to one another for mutual displacement, and for rigidifying the construction;
The arms of the front wheel assembly and the rear wheel assembly can be configured with a height adjusting mechanism;
The cart can be configured with one or more landing wheels disposed at a front, bottom portion of the payload module, and configured for encountering a loading surface of a cargo space of the vehicle;
Each of the front wheel assembly and the rear wheel assembly comprises a collapse activating mechanism wherein a respective wheel assembly begins its collapsing displacement only upon said activating mechanism encountering a barrier of the loading surface;
The collapse activating mechanism can be configured with a roller for smooth displacement onto and over the loading surface;
The arrangement is such that the activating mechanism of the front wheel assembly first encounters the bumper/barrier of the loading surface and the activating mechanism of the rear wheel assembly encounters said bumper/barrier thereafter;
At the collapsed position the arms of the front wheel assembly are disposed between the rear arms and the payload module; according to another configuration, at the collapsed position the arms of the rear wheel assembly are disposed between the front arms and the payload module;
A safety mechanism can be provided for arresting at least the front wheel assembly at its extended position, thereby prevent automatically (unintentional) collapsing of the at least the front wheel assembly; according to a particular configuration the safety mechanism arrests also the rear wheel assembly; the safety mechanism can be a grip arm, a pull lever, a locking notch, etc;
The activating mechanism can be regulated for adjusting to the geometry of different bumpers or edge configurations of a storage surface at the vehicle;
A bumper-encounter of the activating mechanism can be configured with a roller for smooth manipulation as they travel over portions of the bumper of the vehicle. The bumper-encounter also prevents or reduces the risk of scratching or otherwise damaging the bumper and or platform;
The arms of the front wheel assembly comprise a uniform arm articulated to a break-link mechanism (collapsing link mechanism) associated with the front activating mechanism, said break-link mechanism comprising a first link articulated at one end thereof to the base frame and pivotally linked to a second link which in turn is articulated at an end thereof to a wheel arm fitted at a bottom end with a caster, whereby the at an extended, the first link and the second link are geometrically locked at coextensive position. The first link is further configured with a lever articulated with the front activating mechanism, whereupon pivotal displacement of the activating mechanism entails corresponding pivotal displacement of the first link, resulting in collapsing of the link mechanism with corresponding swinging of the wheel arm into its collapsed position;
At the extended, the break-link mechanism of the front wheel assembly supports the wheel arm and prevents it from automatically collapsing;
The rear wheel assembly begins to collapse only after the front wheel assembly has completed its collapsing
The front wheel assembly and the rear wheel assembly are independent from one another;
The rear wheel assembly comprises a parallel link mechanism comprising a wheel arm having a top arm link pivotally articulated at one end to the base frame of the locomotion platform and pivotally coupled at its opposed end to a bottom arm link fitted at its bottom end with a caster; and a parallel link having a first end pivotally secured to the base frame and a second end pivotally articulated to the second arm link, below the pivoting point of the top arm link, wherein said parallel link remains parallely disposed with respect to the top arm link;
The rear activating mechanism comprises an activating link pivotally articulated to the base frame and detachably arrested by a connecting link to the top arm link, whereupon pivotal manipulation of a free end of the activating link entails disengaging of the connecting link and corresponding pivotal displacement of the parallel link mechanism and simultaneous collapsing of the rear wheel arm, between a fully expanded, operative position, and a fully collapsed position;
The rear wheel assembly and the front wheel assembly can each be bilateral and comprise like components at both sides of the cart, however can be configured for cooperation in register in light of inter-connecting bar members extending therebetween;
At a collapsed position the front wheel assembly and the rear wheel assembly can be configured such that they substantially do not project (extend) from the payload module of the cart, i.e. do not project from the footprint of the payload module;
The collapse activating mechanism of one or both of the front wheel assembly and the rear wheel assembly can be manually controlled, e.g. by a Bowden cable mechanism. Manipulating of the collapse activating mechanism can be facilitated also by an operator releasing appropriate knobs, etc.;
The locomotion module can be manually collapsed, upon demand, so that collapsing can take place also without the need to encounter a portion of the storage space;
At the collapsed position, the encountering wheels of the front wheel assembly and the encountering wheels of the rear wheel assembly can be substantially equi-leveled, wherein the cart can be locomoted thereover;
At the collapsed position, the rear wheel assembly and the front wheel assembly reach a folded position wherein the encountering wheels of the front wheel assembly and the encountering of the rear front wheel assembly wheels are equi-leveled;
At the collapsed position the front casters and the rear casters can be stowed, so as not to interferer with rolling of the encountering wheels;
At the collapsed position the cart can be facilitated for locomotion over the respective wheels of the front wheel assembly and the rear wheel assembly, as well as over the encountering wheels;
At the collapsed position the landing wheels and the encountering wheels of the front wheel assembly and the encountering wheels of the rear wheel can be equi-leveled;
The front wheel assembly and the rear wheel assembly can be interchangeable, i.e. each serve as the other one:
The payload module can be detachable from the locomotion platform and the landing wheels are articulated to the payload module, serving at the detached configuration for locomoting the payload module as a hand truck or hand cart
The front wheel assembly and the rear wheel assembly are independent from one another, and sequentially deploy into and from their respective collapsed and extended position.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a top front perspective view of a shopping cart according to the present disclosure, at a fully expanded, riding position;

FIG. 1B is a side view of FIG. 1A, illustrating the shopping cart approaching the rear of a schematically displayed vehicle;

FIG. 1C is a front view of FIG. 1A;

FIG. 1D is a top view of FIG. 1A;

FIG. 1E is an enlarged side view of a rear wheel assembly;

FIG. 1F is an enlarged side view of a front wheel assembly;

FIGS. 2A to 2D are same respective views as FIGS. 1A to 1D, at a first step of mounting the shopping cart into the cargo area of the vehicle;

FIGS. 3A to 3D, 4A to 4D, 5A to 5D, 6A to 6D, 7A to 7D and 8A to 8D are same respective views as FIGS. 1A to 1D, at consecutive steps of mounting the shopping cart into the cargo area of the vehicle;

FIG. 9A is a perspective view of a shopping cart according to a modification of the disclosure, at a fully expanded, riding position; and

FIGS. 9B to 9E are a side view illustrating consecutive steps of collapsing the rear assembly, wherein in FIGS. 9C to 9E the front wheel assembly has been removed for sake of clarity;

FIG. 9F is an enlargement of the portion marked F in FIG. 9C;

FIG. 10 illustrates the shopping cart, with the basket removed, and comprising a manual collapse activating mechanism for both of the front wheel assembly and the rear wheel assembly;

FIGS. 11A to 11F are illustrations of a cart according to another example of the present disclosure, at different configurations and positions thereof; FIG. 11F being an enlargement of the portion marked XI in FIG. 11A;

FIGS. 12A and 12B illustrate a cart wherein the payload module us fitted with a removable divider, seen displaced in FIG. 12B;

FIG. 13 illustrates a cart serving as a utility/tool cart, in while loading onto a truck;

FIG. 14A is a perspective view of a cart according to an embodiment of the disclosure wherein the front wheel assembly is a similar mechanism as the rear wheel assembly, the locomotion platform at the fully expanded, riding position;

FIG. 14B is a side view of FIG. 14A;

FIGS. 14C to 14F are side views illustrating consecutive steps of manipulating the locomotion platform of the cart of FIG. 14A into the fully collapsed position; and

FIG. 14G is a perspective view of FIG. 14E, illustrating the cart at the fully collapsed position.

### DETAILED DESCRIPTION OF EMBODIMENTS

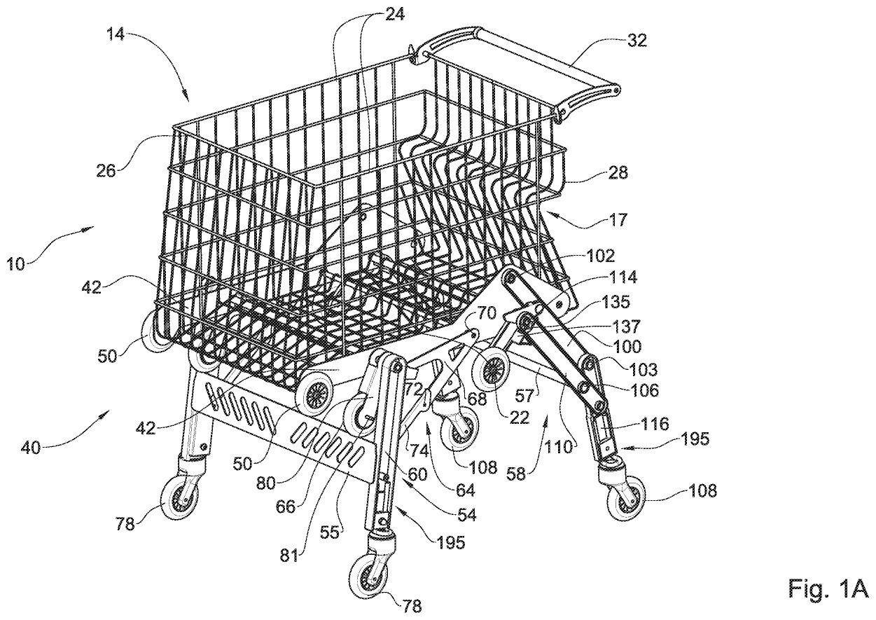

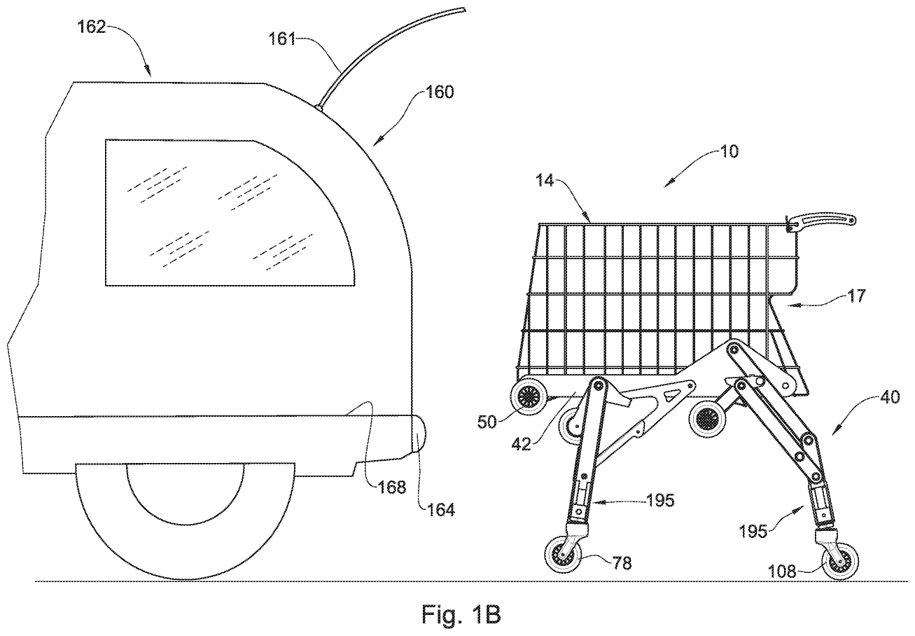

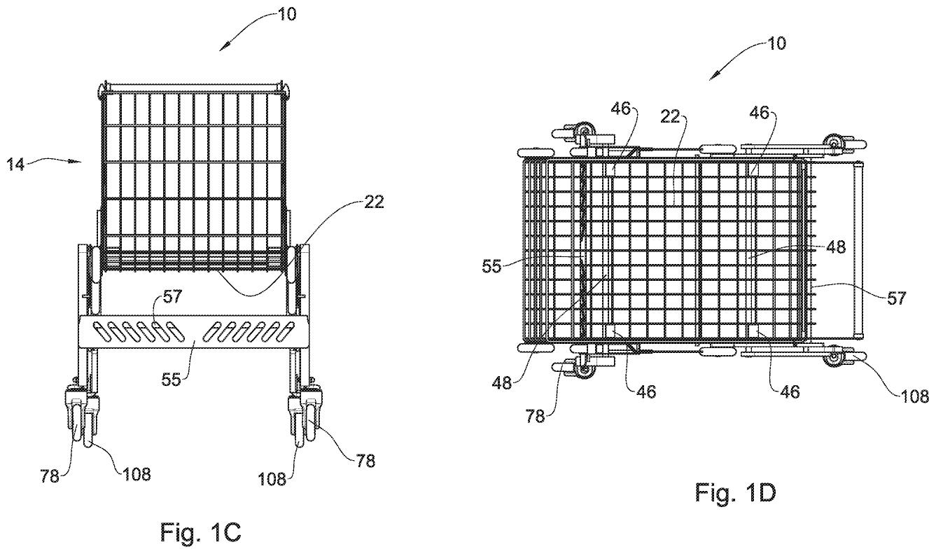

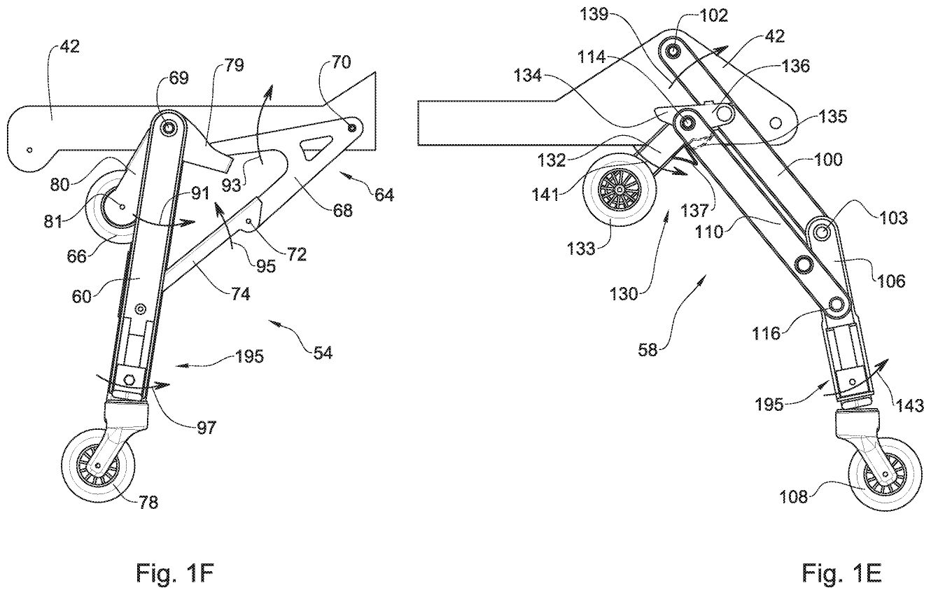

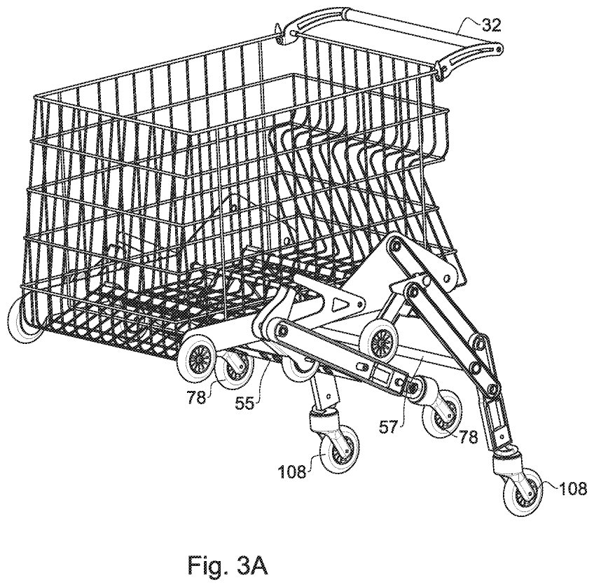

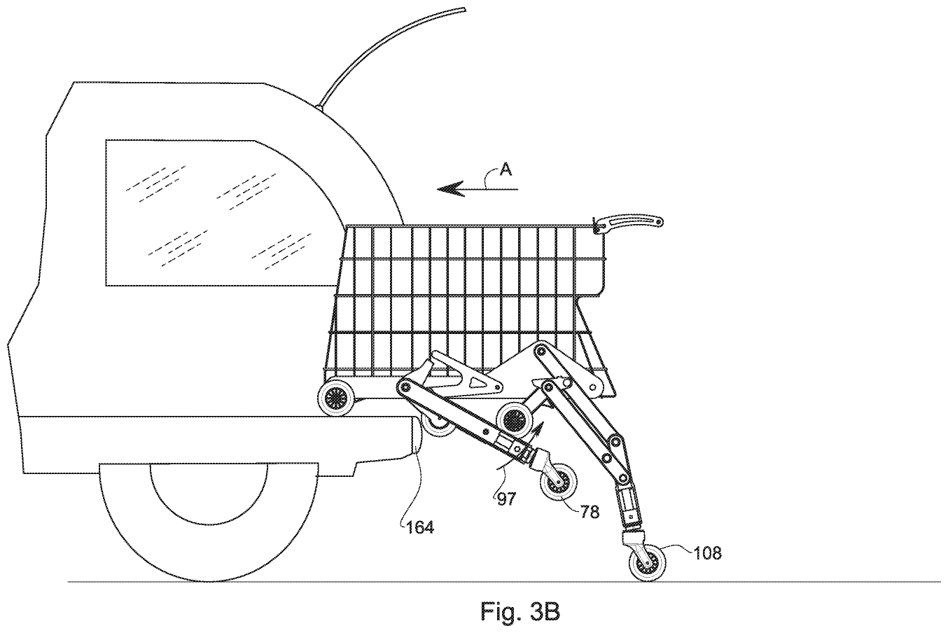

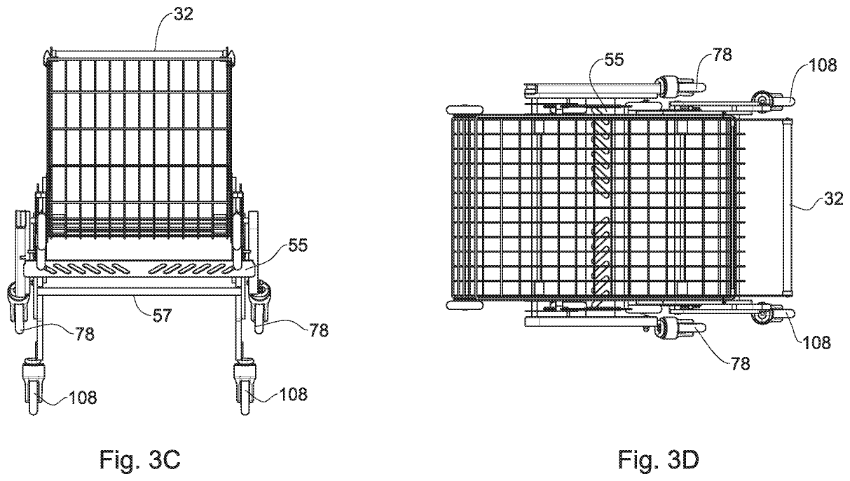

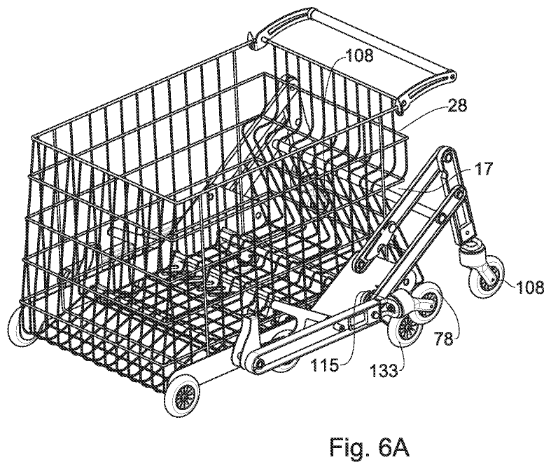

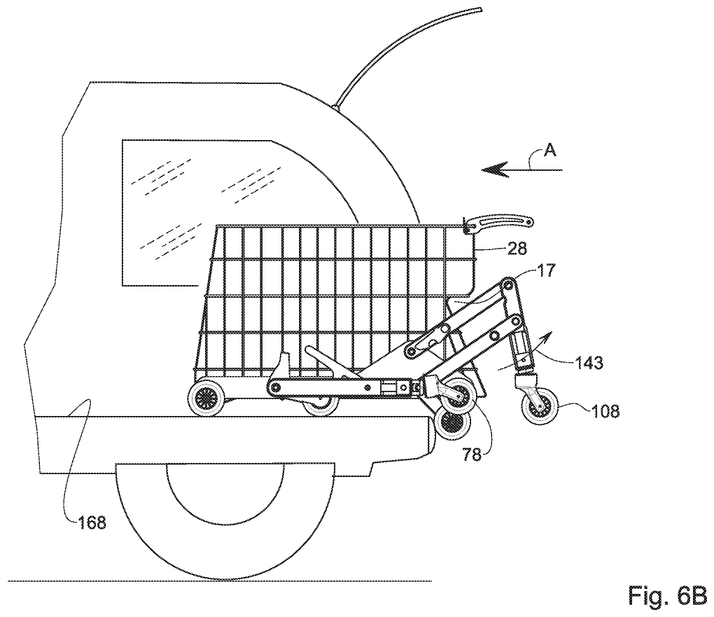

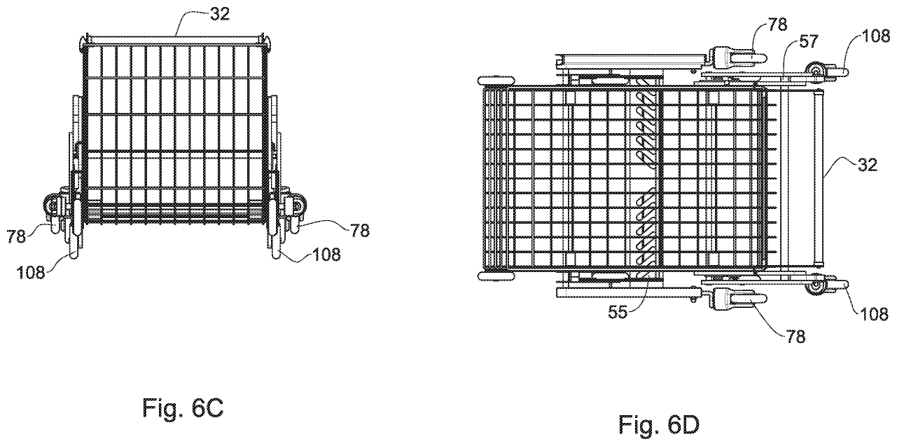

Attention is directed to FIGS. 1 to 10 of the drawings illustrating a cart, configured with a locomotion platform, in accordance with an example the present disclosure. In the illustrated example the cart, generally designated 10, is a shopping cart, though, as mentioned, the cart can be configured with a payload module of any type and for any use, and may differ in shape and size, depending of its nature.

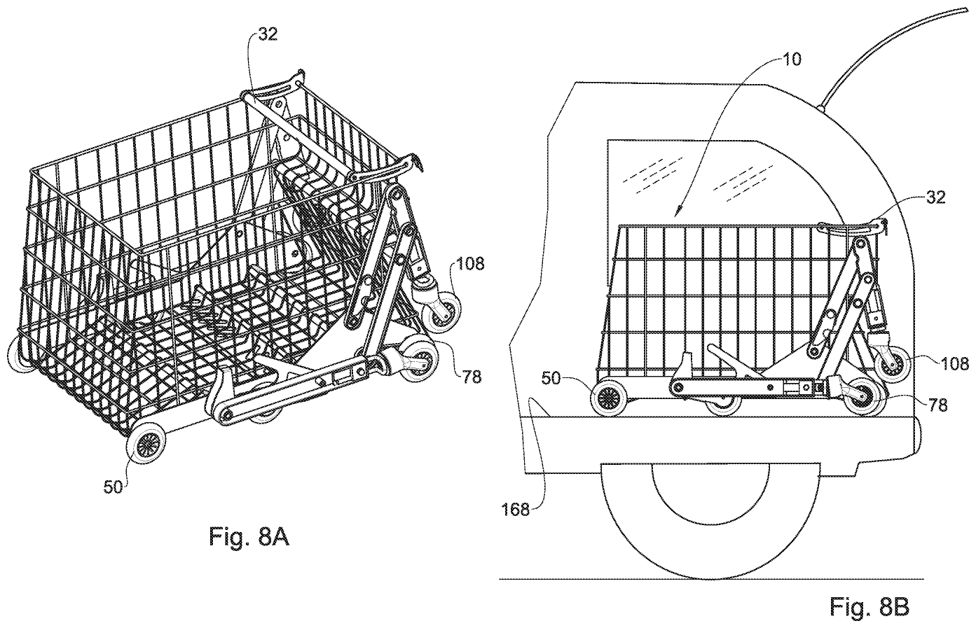

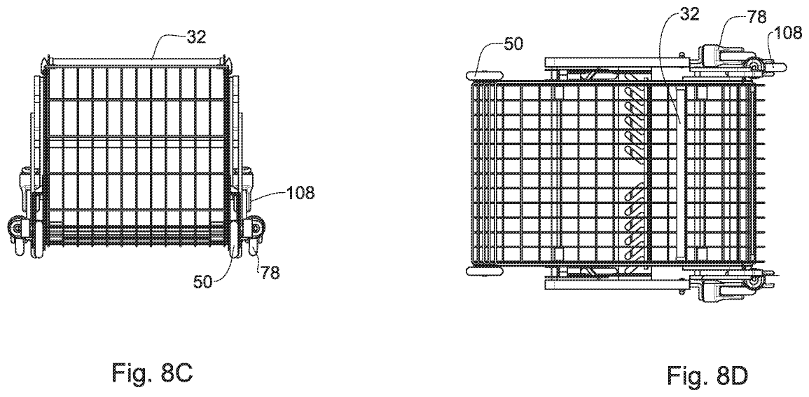

The cart 10 comprises a utility container, namely payload module generally designated 14, said payload module is a solid cage-like structure made of a grid of steel wire, having a generally rectangular shape comprising a base 22, two side walls 24 disposed between a front wall 26 and a rear wall 28. Disposed at a top of the rear wall there is provided a handle bar 32 disposable between an operative pushing/pulling position (FIGS. 1 to 7) and a collapsed/stowing position (FIG. 8). It is appreciated that the handle bar 32 can be arrested at several intermediate locations, for convenience of a user.

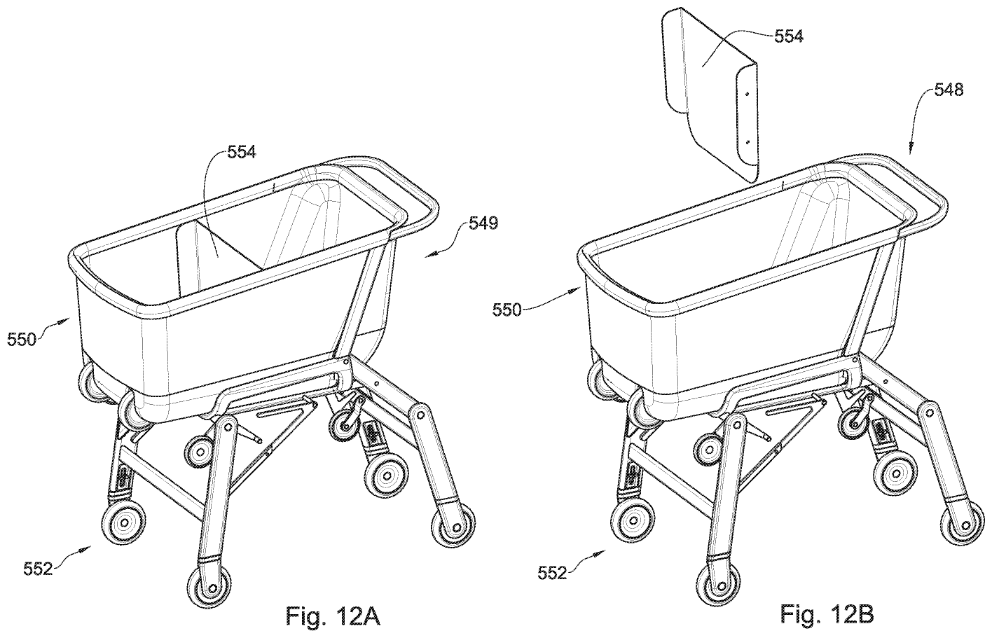

According to some examples (not shown) the payload module can comprise a child seat (fixed or removable), or the payload module can be compartmented (fixedly or removable as illustrated in FIG. 12, discussed herein after) and further, the entire payload module walls can be collapsible such that at a stowed position the cart/payload module occupies minimum space.

The cart 10 further comprises a locomotion platform generally designated 40 and configured for bearing the payload module 14. In the present example the payload module 14 is detachably mounted over a base frame of the locomotion platform 40 and is secured in place by upwardly extending frame walls 42 of the base frame, and latches 46 (best seen in the top vies) arresting interconnecting bars 48 disposed between the frame walls 42.

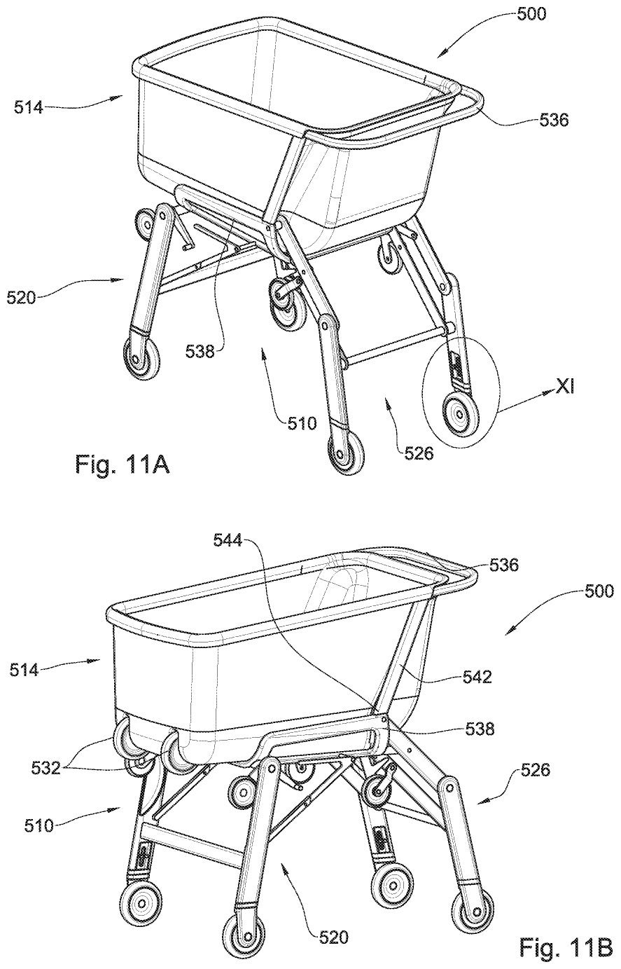

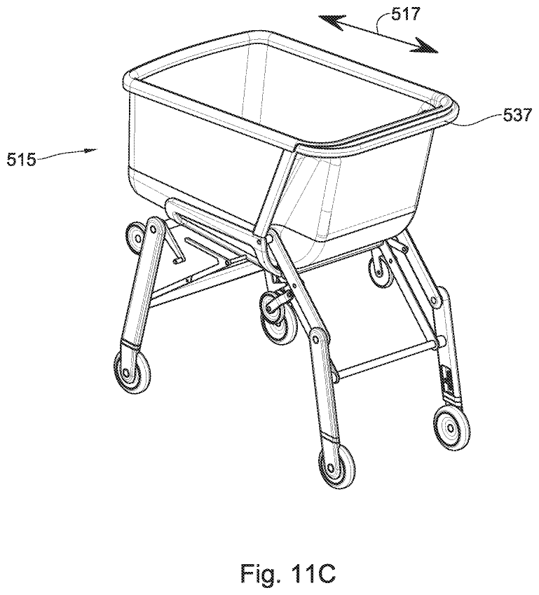

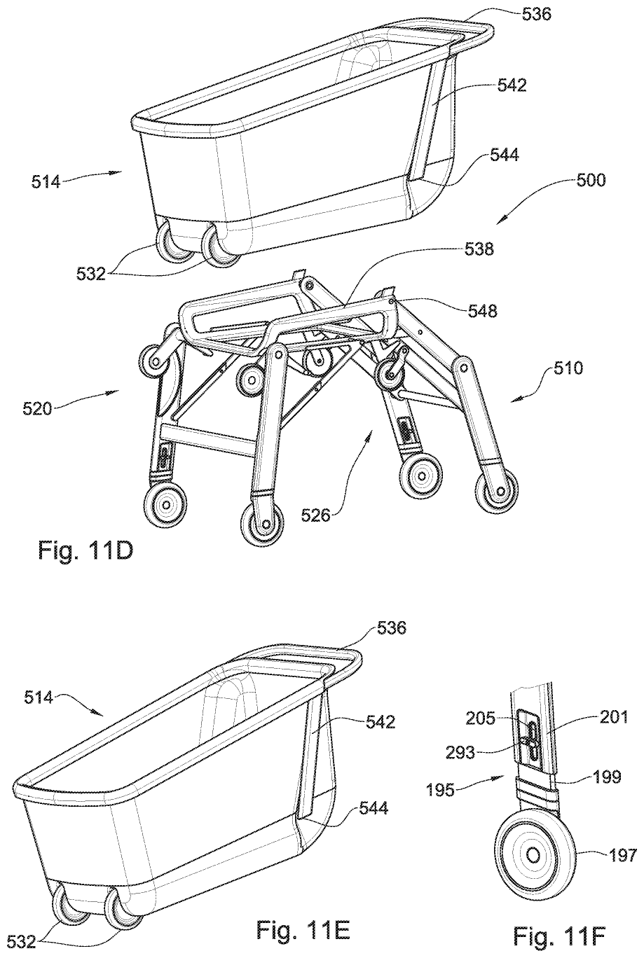

Thus, it is appreciated that the cart can be adopted for different purposes, and a different payload module (e.g. as discussed with reference to FIG. 11) can be fitted over the locomotion platform 40, depending on the intended use.

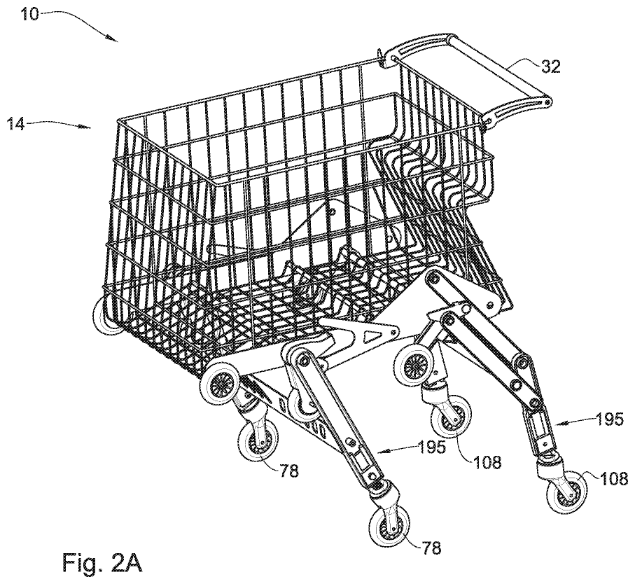

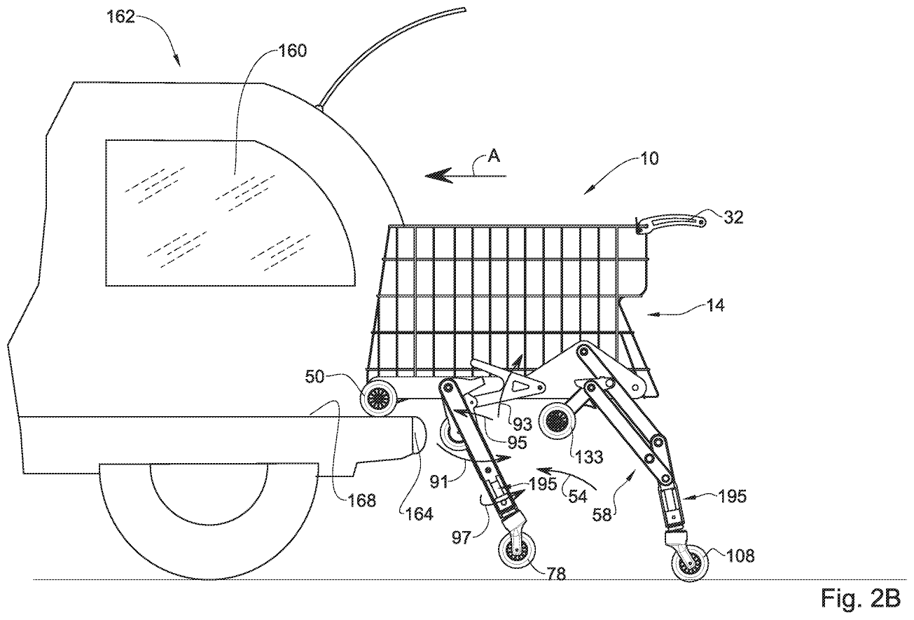

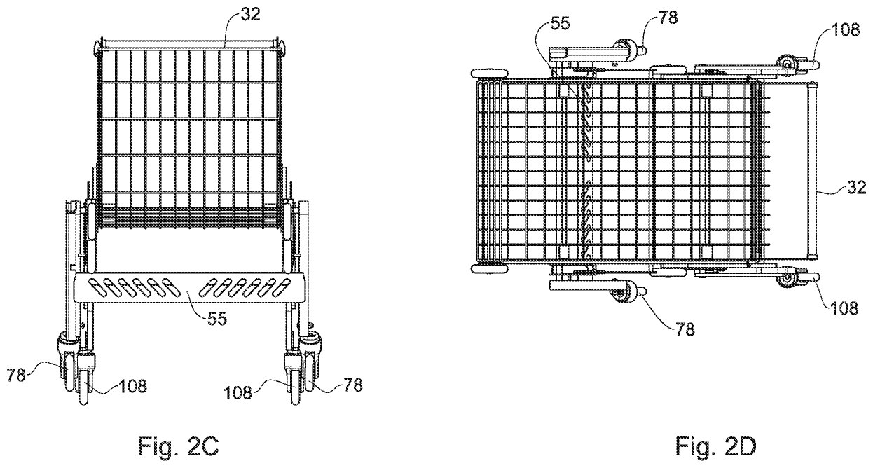

The locomotion platform 40 comprises a pair of landing wheels 50 disposed at a front, bottom portion of the frame walls 42 of the payload module 14, said landing wheels 50 configured for encountering a loading surface of a cargo space of the vehicle, at seen in FIG. 2B and as will be discussed herein after in further detail. It should be noted that one or more landing wheels can be provided, or a rolling cylinder (not shown), however with several such wheels offering improved stability as opposed to one wheel.

It is appreciated that the cart is in fact suitable for loading/unloading with respect to any elevated surface such as a stage, ramp, platform, etc. and thus the term vehicle is used herein the specification and claims as an example, and denotes a broad meaning.

The locomotion platform 40 further comprises a front wheel assembly generally designated 54 (FIG. 1D) and a rear wheel assembly generally designated 58 (FIG. 1E). The front wheel assembly 54 and the rear wheel assembly 58 are displaceable between a fully extended, deployed, riding position (FIG. 1) and a fully collapsed, stowing position (FIG. 8).

In the present example, and as seen in the drawings, the front wheel assembly 54 and the rear wheel assembly 58 are each bilateral and comprise like components at both sides of the cart, and are configured for cooperation in register in light of inter-connecting bar members 48, 55 and 57 extending therebetween.

As best seen in FIG. 1D, each side of the front wheel assembly 54 comprises a uniform arm 60 pivotally articulated at 69 to the articulated to the frame wall 42. A break-link mechanism 64 (a so-called collapsing link mechanism) is associated with a front activating mechanism in the form of an encountering wheel 66. The break-link mechanism 64 comprising a triangular link 68 articulated at one end 70 to the base frame walls 42 and is pivotally linked at 72 to a second link 74 which in turn is articulated at an end thereof to the wheel arm 60, fitted at a bottom end with a caster 78.

At the fully extended, deployed, riding position (FIG. 1), the triangular link 68 and the second link 74 are geometrically locked at a coextensive position. The triangular link 68 is in communication at a top arm thereof with a lever arm 79 of a pivotable lever 80 articulated with the encountering wheel 66, with a laterally projecting pushing pin 81 (in the present example extending coaxial with encountering wheels 66) configured for engaging with a fore edge wheel arm 60. The arrangement being such that pivotal displacement of the pivotable lever 80 (in direction of arrow 91) entails corresponding pivotal displacement of the triangular link 68 (in direction of arrow 93), resulting in collapsing of the break-link mechanism 64 (in direction of arrow 95), and upon further displacement the pushing pin 81 encounters the fore edge wheel arm 60 causing corresponding swinging of the wheel arm 60 into its collapsed position, progressive along with pivotal displacement of the pivotable lever 80 (in direction of arrow 97).

Thus, it is seen that the pushing pin 81 encounters the fore edge wheel arm 60 (FIGS. 2A and 2B) only after the break-link mechanism 64 has pivotally displaced into its unlocked position.

It is noted that at the extended, (FIG. 1) the break-link mechanism 64 of the front wheel assembly 54 supports the wheel arm 60 and prevents it from automatically collapsing.

The rear wheel assembly 58 (best seen in FIG. 1E) comprises a parallel link mechanism comprising a wheel arm having a top arm link 100 pivotally articulated at one end 102 to the frame walls 42 of the locomotion platform, and pivotally coupled at a pivoting point 103 of its opposed end to a bottom arm link 106 fitted at its bottom end with a caster 108. A parallel link 110 has a first end thereof pivotally secured at 114 to the frame walls 42 and a second end pivotally articulated at 116 to the second arm link 106, however below the pivoting point 103 of the top arm link 100, wherein said parallel link 110 remains parallely disposed with respect to the top arm link 100.

According to one particular example, pivotal displacement of the bottom arm link 106 is restricted whereupon at the fully extended position as it encounters the rear inter-connecting bar member 57.

The rear activating mechanism 130 comprises an activating link 132 pivotally articulated at axle pin 114 to the frame walls 42 and fitted at a fore end thereof with a rear activating mechanism in the form of an encountering wheel 133. The activating link 132 is detachably arrested by a hook portion 134 of a connecting link 136 arresting the top arm link 100 pivot at axle pin 114 and preventing pivotal displacement thereof. Furthermore, the activating link 132 is configured adjacent a top end thereof with a rearward projecting crescent member 135 (shown in dashed lines in FIGS. 1A and 1E) configured for encountering connecting link 136, and a laterally projecting engaging member 137 configured for encountering parallel link 110.

The arrangement is such that as the rear encountering wheels 133 encounter the barrier, the activating link 132 pivots in direction of arrow 141, whereby the tip of crescent member 135 (shown in dashed lines in FIGS. 1A and 1E) encounters connecting link 136 and resulting in pivotal displacement of the connecting link 136 in direction of arrow 139 to thereby disconnect hook portion 134 from axle pin 114 into an unlocked position. As the encountering wheels 133 continue their displacement (in direction of arrow 141) the engaging members 137 encounter an edge of the parallel link 110 entailing its displacement rearwards to commence folding/collapsing of the rear wheel assembly 58.

At the fully extended, deployed, riding position (FIG. 1), the top arm link 100 is arrested and engaged by connecting link 136, preventing collapse thereof. However, upon encountering wheel 133 encountering a barrier (bumper) of a loading area the activating link 132 is impacted and pivots (in direction of arrow 141), resulting in disengagement of hook portion 134 from arresting the axle pin 114 and facilitating pivotal displacement of the rear wheel assembly 58 in direction of arrow 143 until a fully collapsed position (FIG. 8).

It is appreciated that interconnecting bars members 48, 55 and 57 ensure mutual and simultaneous displacement of the left side and right side wheel assemblies, and further increase rigidity and stability of the cart.

In use, the cart 10 is manipulable between its fully extended, deployed, riding position (FIG. 1), and the fully collapsed, stowing position (FIG. 8), in the following sequence.

In FIG. 1 the cart 10 is configured for riding just like any cart, with casters 78 and 108 riding over a ground surface, the cart manipulable by handle bar 32. When it required to transfer the cart 10 into a cargo space 160 of a vehicle 162 (or, for example, to mount the cart on a ramp, etc.), the cart is pushed towards the vehicle 162 (direction of arrow A) and at a first instance the landing wheels 50 at the fore end of the cart encounter the loading surface 168 of the vehicle. As the cart 10 is further pushed against the rear bumper 164 (FIG. 2B), the front activating mechanism, namely encountering wheels 66 encounter the bumper 164 (acting as an obstacle/barrier), resulting in pivotal displacement thereof (in direction of arrow 91), entailing corresponding pivotal displacement of the triangular link 68 (in direction of arrow 93), and collapsing of the break-link mechanism 64 (in direction of arrow 95) with corresponding swinging of the wheel arm 60.

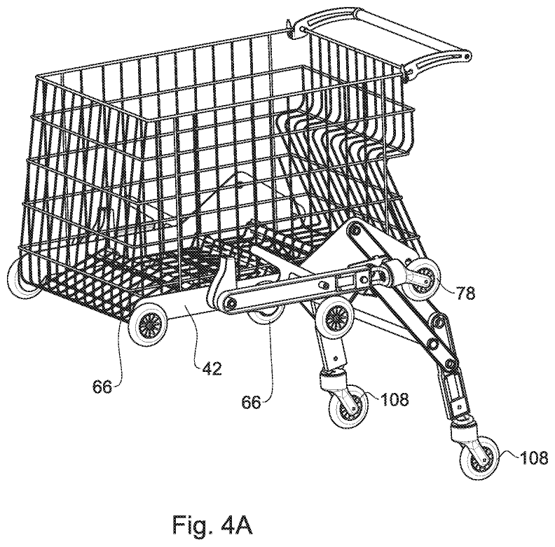

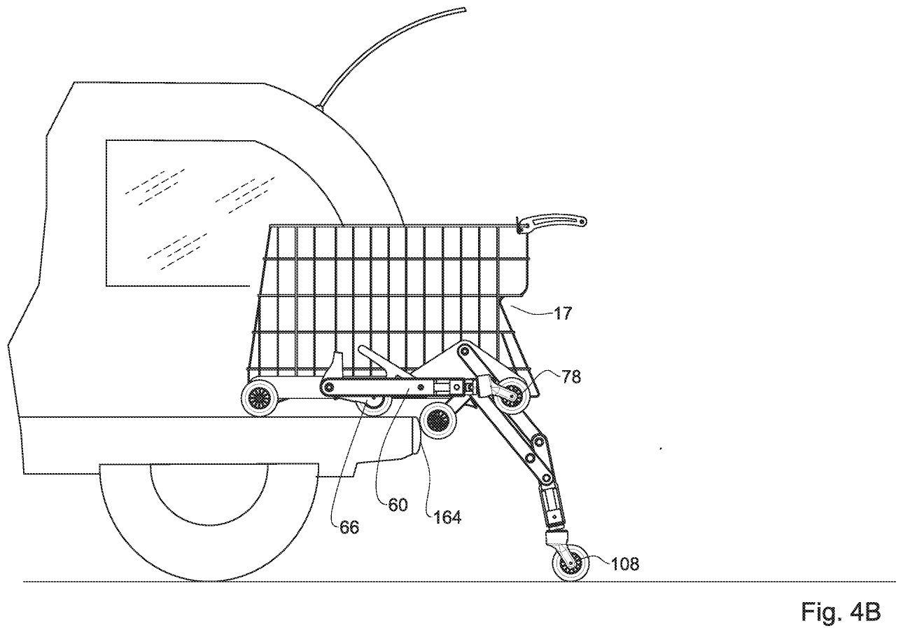

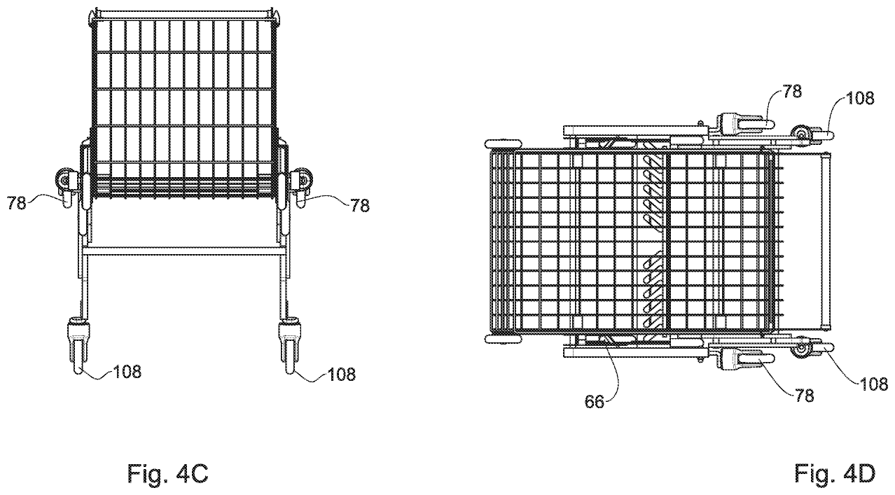

As the cart 10 is further pushed into the cargo space 160 of the vehicle the bumper 164 applies further pressure over the front wheel assembly 54, resulting in detaching the casters 78 from the ground and progressive collapsing of the front wheel assembly 54 until obtaining its fully collapsed position as in FIG. 4B. It is appreciated that at this position the rear wheel assembly 58 is still at its load bearing position. i.e. fully deployed, such that if an operator of the cart lets go of the cart, it will not topple over.

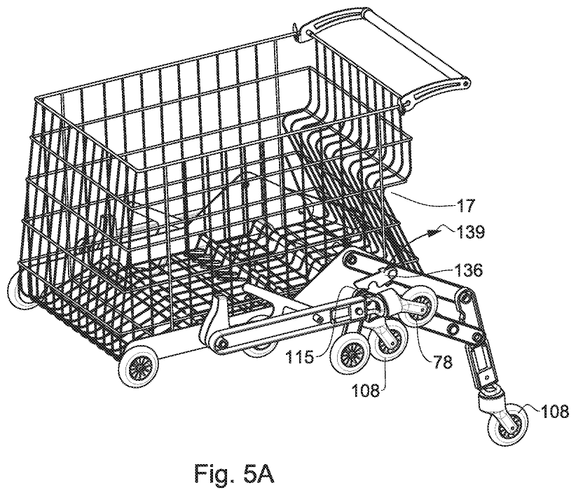

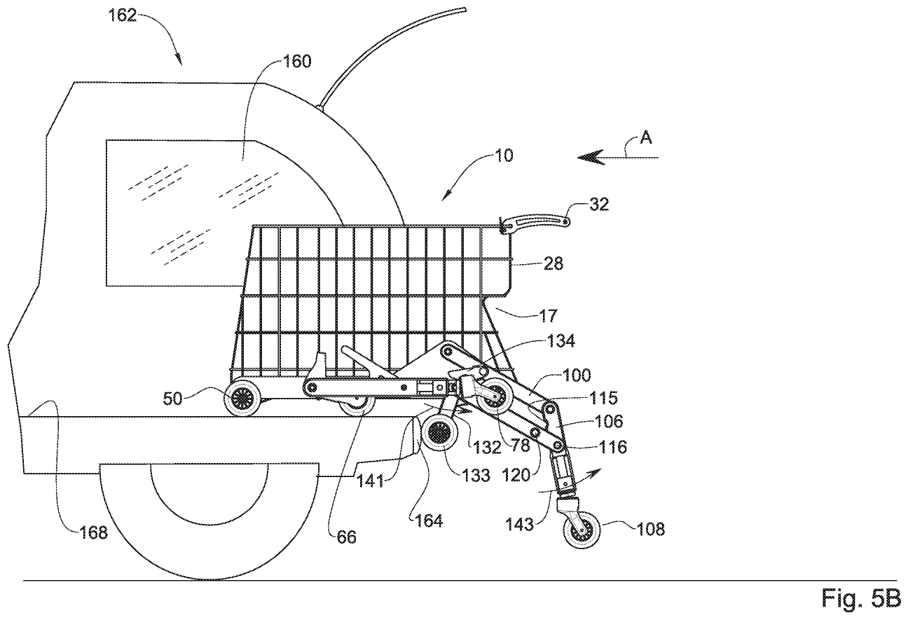

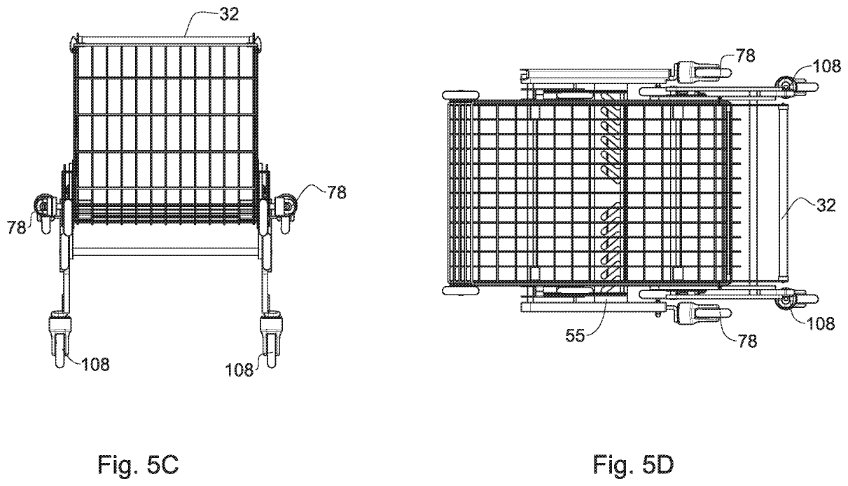

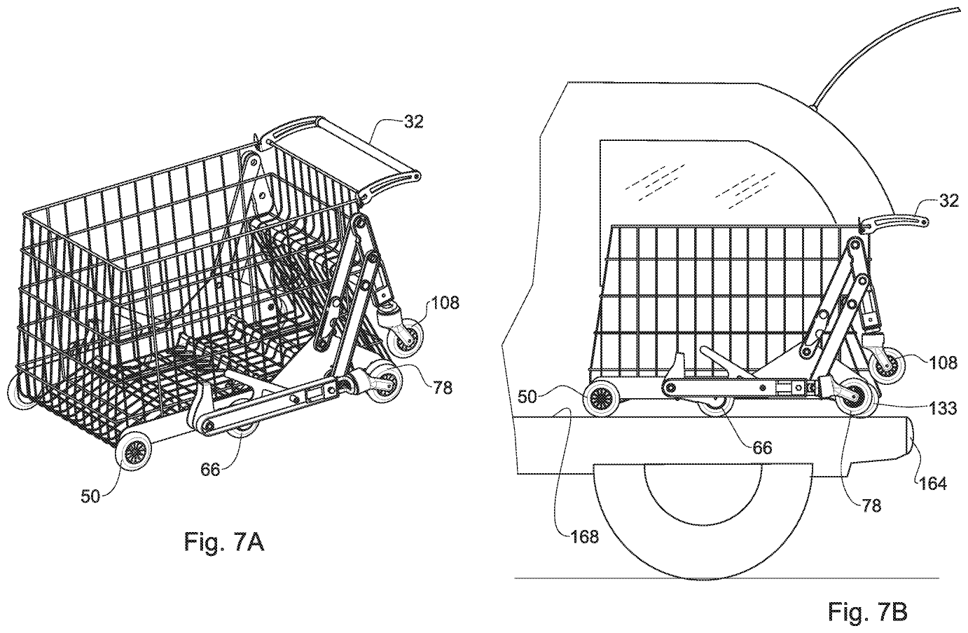

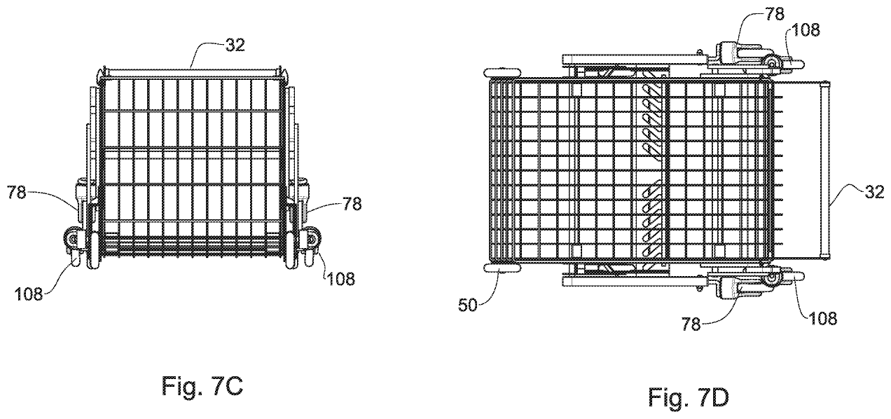

As the cart 10 is further pushed into the cargo space 160, riding over cargo surface, by landing wheels 50 (optionally also aided by encountering wheel 66), the rear encountering wheels 133 encounter the bumper 164 (FIG. 5B) resulting in pivot of the activating link 132 (in direction of arrow 141), and consequentially resulting in disengagement of hook portion 134 from arresting the pivot 115 and facilitating pivotal displacement of the rear wheel assembly 58 in direction of arrow 143 until a fully collapsed position (FIG. 7). At this position the casters 108 are disposed above the cargo surface 168 and the cart is supported over the landing wheels 50 and the encountering wheels 133.

A final collapsing position, which can take place also earlier, is collapsing the handle bar 32 as illustrated in FIG. 8. Then, the cargo door 171 of the vehicle 162 can be closed. It is noted that the cart 10 can be secured to the cargo surface 168, e.g. by suitable latched or straps (not shown).

It is noted that that at the collapsed position (FIGS. 7C and 8C) the arms of the front wheel assembly are disposed between the arms of the rear wheel assembly and the payload module (or rather the frame walls 42).

It is seen that at the fully collapsed position of the front wheel assembly 54, the front wheel assembly reached a final collapsed position (FIG. 4) wherein the encountering wheel 66 project below a bottom face of the cart basket (namely the frame walls 42) and are substantially equi-leveled with the landing wheels 50. This is facilitated by the front arms engaging a stopper portion of the frame. Likewise, at the collapsed position the rear wheel assembly 58 assumes a configuration wherein the rear arms are collapsed over side walls of the basket of the cart and substantially do not project beyond boundaries thereof, as there is configured an depression 17 at the rear wall 28, receiving the rear wheel interconnecting bar and arresting it a fully folded position, such that the encountering wheels 66 project below the bottom face of the cart basket (namely the frame walls 42) and are substantially equi-leveled with the landing wheels 50.

Now, when it is required to withdraw the cart 10 from the vehicle 162 (or any elevated surface, as discussed hereinabove), a reverse sequence of operations takes place. Accordingly, first the handle 32 is unfolded and then the cart is gradually pulled out of the vehicle, allowing first the rear wheel assembly 58 to automatically displace into the erect, riding position. However, displacement of the rear wheel assembly takes place gradually (i.e. the top arm link 100 and the bottom arm link 106 reach their final riding position only as the encountering wheel 133 disengages from the loading surface 168 of the vehicle, and upon interlocking at this position, allowing the rear casters 108 to engage the ground.

As the cart 10 is further pulled out of the vehicle, now already riding over the rear wheel assembly 58, front wheel assembly 54 begins to gradually displace into the erect, riding position and likewise, the front wheel arms 60 reach their final riding position only as the front encountering wheel 66 disengages from the loading surface 168 of the vehicle, and upon arresting at this position, allowing the front casters 78 to engage the ground, facilitating riding the cart 10 over the ground.

As seen in the drawings, with an enlarged view in the example illustrated in FIG. 11F, each of the front casters 78 and the rear casters 108 is articulated at the bottom end of the front arm 60 and the rear bottom arm link 106, respectively, through a height adjusting mechanism 195, such that the height of the cart 10 can be adjusted in conjunction with the height of different loading surfaces of vehicles, loading rams, etc., and if the need arises, to level the cart. Such a height adjusting mechanism 195 can be, for example, a screw coupling engagement, an extension piece etc. In FIG. 11F a caster 197 is rotatably articulated to an end piece 199, the latter being telescopically received within a bottom leg portion 201 and configured for arresting at a desired extension level upon fastening of a bolt 203 extending from end piece 199 and slidingly received within a recess 205 formed at the bottom leg portion 201.

The arrangement is such that the wheel assemblies displace sequentially, namely upon loading the cart over a platform the rear wheel assembly begins its collapsing procedure only after the front wheel assembly has completed its collapse, and vise versa upon deploying the cart and unloading it from the platform, the front wheel assembly begins its deployment into the extended position only after the rear wheel assembly has reached its fully extended position and is ready for bearing loads.

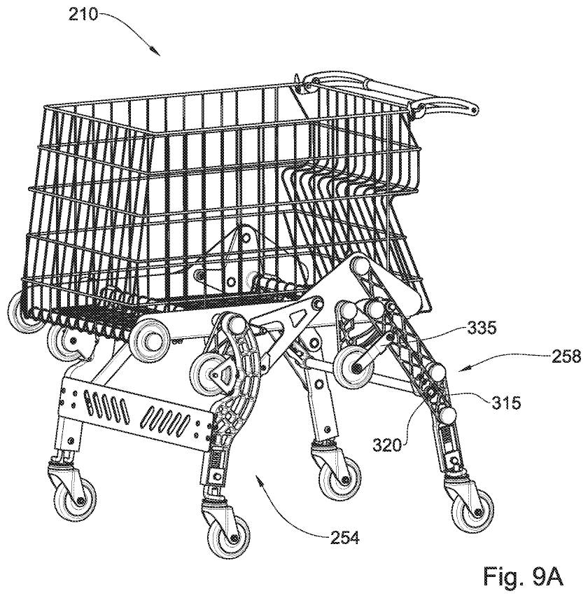

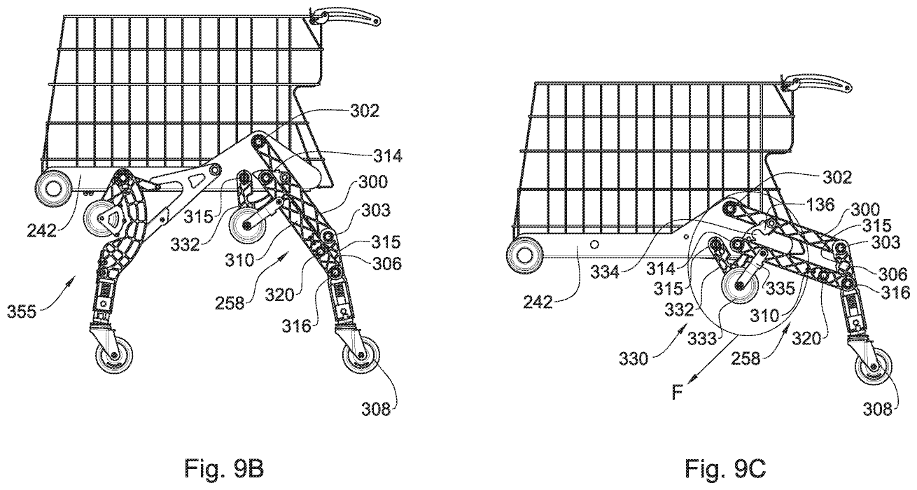

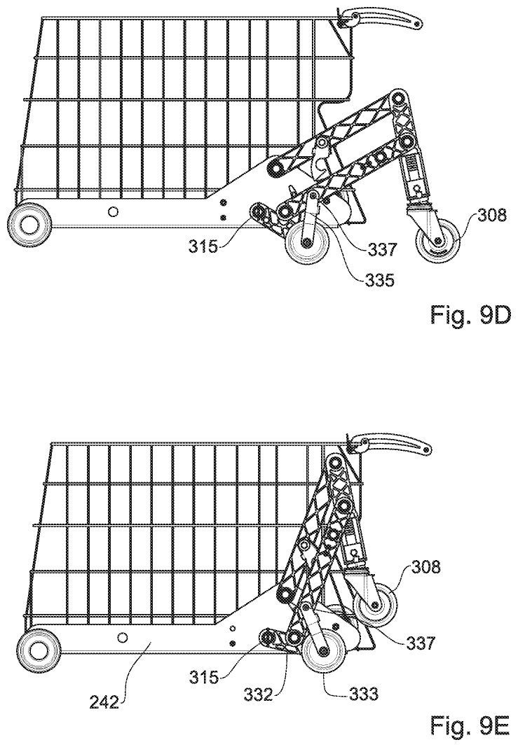

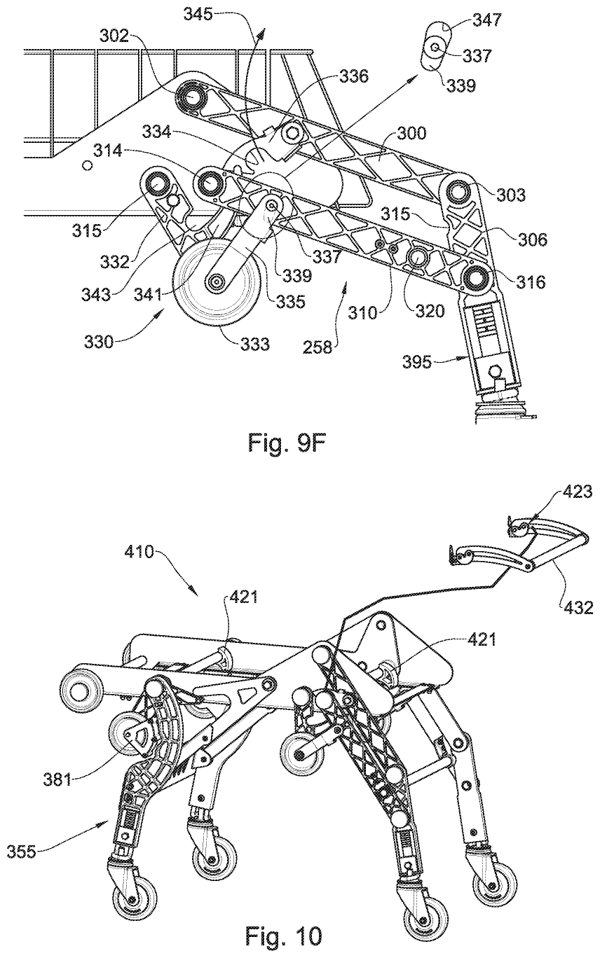

In FIGS. 9A through 9E there is illustrated a modification of the previous example, wherein the main difference resides in the rear wheel assembly 258, and wherein like elements are designated with like reference numbers, however shifted by 200.

The cart 210 is illustrated in full in the perspective view of FIG. 9A whilst FIGS. 9B to 9E are front views, and wherein at FIGS. 9c to 9E the front wheel assembly 254 has been removed for sake of clarity.

Similar to the previous example of FIGS. 1 to 8, the rear wheel assembly 258 comprises a parallel link mechanism comprising a wheel arm having a top arm link 300 pivotally articulated at one end 302 to the frame walls 242 of the locomotion platform, and pivotally coupled at its opposed end 303 to a bottom arm link 306 fitted at its bottom end with a caster 308. A parallel link 310 has a first end thereof pivotally secured at 314 to the frame walls 242 and a second end pivotally articulated at 316 to the second arm link 306, however below the pivoting point 303 of the top arm link 300, wherein said parallel link 310 remains parallely disposed with respect to the top arm link 300.

The parallel link 310 further comprises a stopper member 320 laterally projecting and configured for limiting pivotal displacement of the bottom arm link 306 as they encounter each other (at point of contact 315).

The rear activating mechanism 330 comprises an activating link 332 pivotally articulated at 315 to the frame walls 242 and fitted at a fore end thereof with a rear activating mechanism in the form of an encountering wheel 333. The activating link 332 is detachably arrested by a hook portion 334 of a connecting link 336 arresting the top arm link 300 and preventing pivotal displacement thereof.

In FIG. 9 the front wheel assembly generally designated 355 is configured with a laterally extending triangular member 381 replacing the pushing pin disclosed in the previous examples and configured for encountering the fore edge wheel arm only after the break-link mechanism has pivotally displaced into its unlocked position.

As can best be seen in FIG. 9F, the rear wheel assembly 258 is further configured with an activating mechanism limiting mechanism comprising a limiting link 335 pivotally articulated at one end to the encountering wheel 333 and having its opposite end fitted with an arm articulating pin 337 slidingly displaceable within an elongate groove 339 configured at the parallel link 310. The arrangement being such that displacement of the encountering wheel 333 (upon encountering or a barrier of the loading surface) entails initial pivotal displacement of the activating link 332 with the associated arced lever portion 341 to thereby pivotally displace arm 336 in direction of arrow 345 (FIG. 9F) so that the hook portion 334 disengages from pivot axle 314, this being facilitated owing to arm articulating pin 337 being slidingly received within the elongate groove 339, thereby commencing unlocking of the wheel assembly.

The arrangement is such that collapsing the rear wheel assembly 258 or deploying it into the fully extended, takes place substantially as discussed hereinabove in connection with the first embodiment, however wherein parallel link 310 is pushed rearwards, into its collapsed position, by virtue of pin 337 displacing to the end of the elongate groove 339, thus bearing against the wall portion marked 347 (as in FIG. 9F) and pushing parallel link 310 into completing its folding displacement.

It is also seen that the activating link 332 is configured with an arced lever portion 341, having an arresting recess 343, whereby at a folding procedure the pivot 314 slides over the arced lever portion 341 until the pivot 314 nests at the arresting recess 343 (at the folded position the hook portion 334 of a connecting link 336 is disengaged from the pilot point 314).

In the illustration of FIG. 10 there is yet a modification of the cart wherein the payload module (14 in the example of FIGS. 1 to 8) is removed by unlocking latches 421). In this example the locomotion platform 410 is configured with a manual collapse activating mechanism comprising, for example, a Bowden cable mechanism or a hydraulic mechanism activated by a lever 423 fitted at the handle bar 432, wherein manipulating the lever 423 results in releasing of arresting levers 441 and 442 configured at the front wheel assembly 454 and at the rear wheel assembly 458, respectively.

Notable, such a manual collapse activating mechanism can activate one or both of the front wheel assembly and the rear wheel assembly, typically gradually.

Further attention is now directed to FIGS. 11A to 11F illustrating yet an example of a cart generally designated 500, comprising a locomotion platform 510 and a payload module 514. The front wheel assembly 520 and the rear wheel assembly 526 are substantially similar to the front wheel assembly and the rear wheel assembly disclosed herein before, and operate substantially alike, whereby reference is made thereto. However, it is seen that in the examples of FIGS. 11A to 11F the payload module 514 is a light weight, plastic molded basket-like element, configure at a bottom front end thereof with a pair of landing wheels 532 and a handle 536 at a top rear end of the basket. The basket 514 is detachably articulated to the locomotion platform 510, such that at the assembled position it is received in a cradling portion 538 at a top of the locomotion platform 510 and is readily and easily detachable and securely mounted back.

In use, the cart 500 operates as disclosed hereinbefore as far as locomoting over the ground and as far as mounting onto an elevated surface while automatically collapsing the front wheel assembly 520 and the rear wheel assembly 526, and reversely upon unloading from the elevated surface and allowing the front wheel assembly 520 and the rear wheel assembly 526 to automatically displace into the fully extended (FIGS. 11A, 11B and 11D). Once detached (FIG. 11D) from the locomotion platform 510 the basket 514 can be manipulated (FIG. 11E) over the landing wheels 532 by aid of the handle 536, which remain articulated to the basket.

It is seen, best in FIG. 11D, that the handle 536 extends at the top end of the basket 514 and is articulated to side supports 542 each having a bottom coupler 544 which at the assembled position are configured for interconnecting with locking member 548 of the locomotion platform 510, to thereby rigidify the structure, such that pulling/pushing forces applied to the cart through the handle 536 are transferred to the locomotion platform.

FIG. 11C illustrates a slight modification of the previous example, the difference residing in that the handle 537 is slidingly articulated to the payload module, namely basket 515, such that it is displaceable between a fully withdrawn position (similar to that illustrated in FIGS. 11A, 11B), and a fully retracted position (FIG. 11C) as it is flush with the rear top edge of the basket 515 upon slidingly displacing in direction of arrow 517 (stow position). It is appreciated that a handle locking arrangement can be provided (not shown), for arresting the handle 537 at either of its respective positions.

FIGS. 12A and 12B are directed to yet a modification of a cart 549, comprising a payload module, namely basket 550 mounted over a locomotion platform 552, wherein the basket 550 is configured with a detachable divider 554 for compartmenting the basket into respective front and rear compartments (FIG. 12A). It is appreciated that the basket can be configured with several dividers, and furthermore, that the basket can be configured with different other utility elements, such as a child seat, a powerbank, one or more holders (e.g. for cellular devices, bags and the like), advertising support, digital shopping means, and the like (not illustrated).

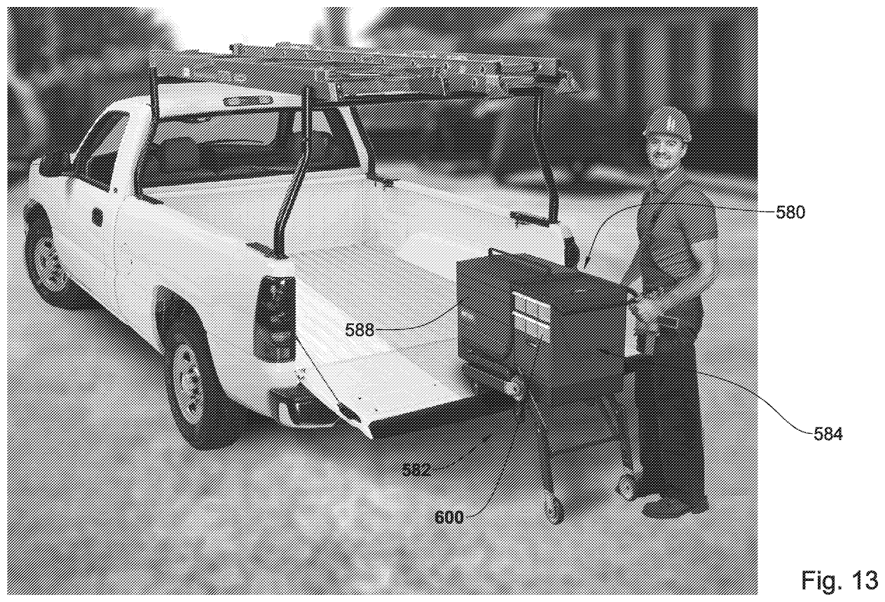

FIG. 13 illustrates how a utility cart according to the disclosure, generally designated 580, comprising a locomotion platform 582 according to any of the examples discussed herein, and a utility payload module 584 configured with sub compartments such as a detachable tool caddy 588 and a compartmented cabinet 600.

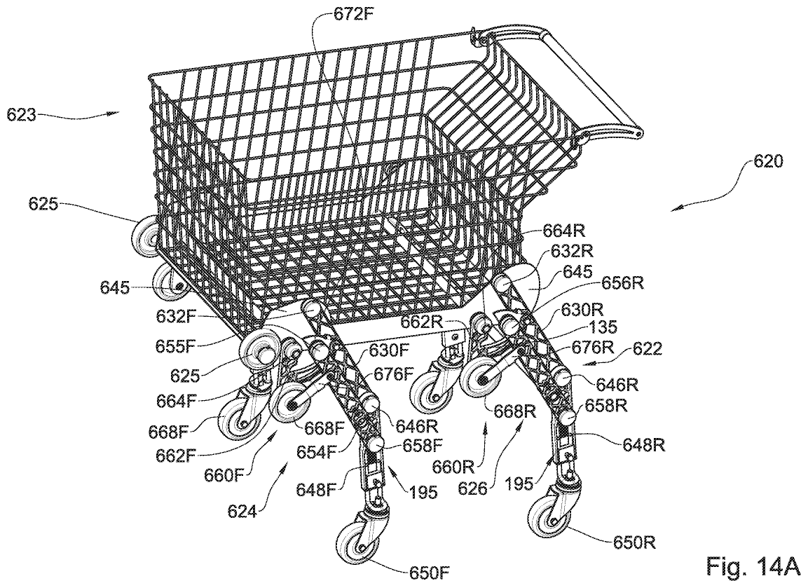

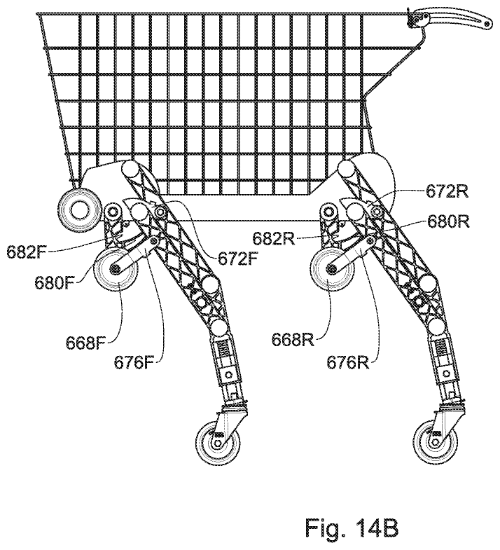

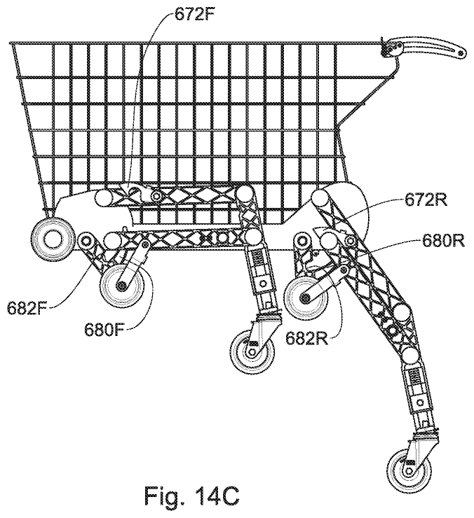

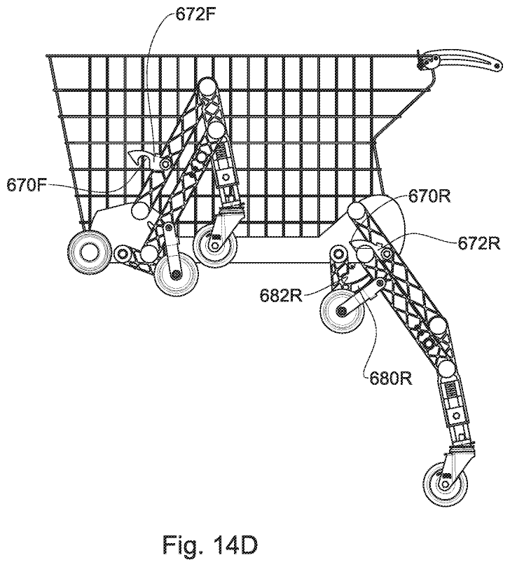

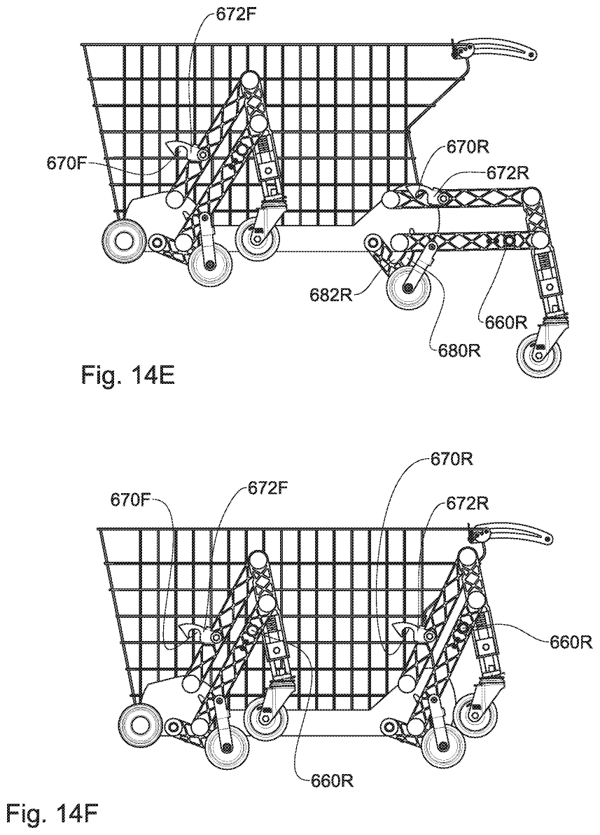

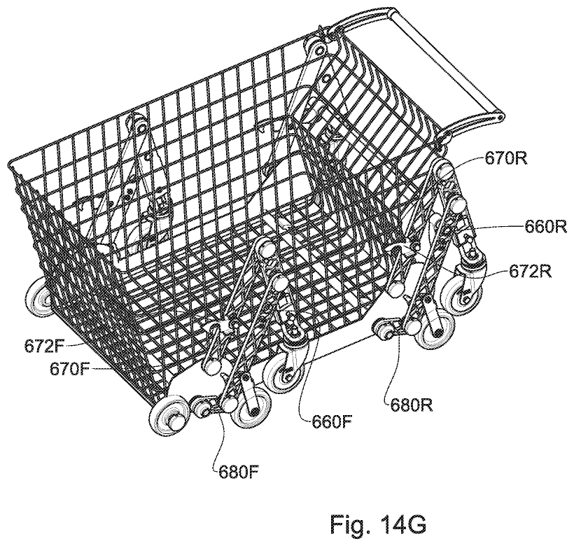

Turning now to FIGS. 14A to 14G of the drawings there is illustrated a cart according to yet an embodiment of the disclosure, generally designated 620. The difference between this embodiment and the previous embodiments resides in that the locomotion platform 622 comprises a front wheel assembly 624 configured similar to the rear wheel assembly 626, and accordingly operates in the same fashion as well, namely displacing between the fully extended (FIGS. 14A and 11B) and the fully folded/collapsed position (FIGS. 14F and 14G) takes place similarly to the arrangement as disclosed hereinbefore with particular reference to the example of FIGS. 9A to 9F.

The cart 620 is illustrated in full at a perspective view in FIGS. 14A and 14G, whilst FIGS. 14B to 14F are side elevations, wherein like elements configured at the front wheel 624 and at the rear wheel assembly 626 are designated with like reference numbers, however with indication of F (designated front wheel assembly components), and R (designated rear wheel assembly components), respectively.

The cart 620 is configured with a payload module 623, i.e. a loading basket, according to any example as disclosed herein above, said basket fitted at its fore bottom end with a pair of landing wheels 625, as discussed herein before.

Each of the front and rear wheel assembly comprises a parallel link mechanism fitted with a wheel arm having a top arm link 630R; 630F pivotally articulated at one end 632R; 632F to a frame portion 645 of the locomotion platform 622, and pivotally coupled at its opposed, lower end 646R; 646F to a bottom arm link 648R; 648F, the latter fitted at its bottom end with a height adjusting mechanism (e.g. 195 as in FIG. 11F), fitted at its bottom end with a caster 650R; 650F.

A parallel link 654R; 654F has a first end thereof pivotally secured at 656R; 656F; 656F to the frame portion 645, and a second, bottom end pivotally articulated at 658R; 658F to said bottom arm link 648R; 648F, however below the pivoting point 646R; 646F of the top arm link 630R; 630F, respectively, wherein said parallel link 654R; 654F remains parallely disposed with respect to the top arm link 630R; 630, at all times.

It is seen that the pivot point at the lower end 646R; 646F of the top arm link 630R; 630F is configured with a laterally projecting stopper member configured for limiting pivotal displacement of the bottom arm link 648R; 648F (and of the parallel mechanism) as they encounter each other, so as to restrict pivotal displacement.

An activating mechanism 660R; 660F comprises an activating link 662R; 662F pivotally articulated at 664R; 664F to the frame portion 645, and is fitted at a fore end thereof with a rear activating mechanism in the form of an encountering wheel 668R; 668F disposed at an end of a limiting link 676R; 676F. The activating link 662R; 662F is detachably arrested by a hook portion 670R; 670F of a connecting link 672R; 672R arresting the top arm link 630R; 630F and preventing pivotal displacement thereof.

It is also seen that the activating link 662R; 662F is configured with an arced lever portion 680R; 680F, having an arresting recess 682R; 682F, whereby at a folding procedure the pivot 632R; 632F slides over the arced lever portion 680R; 680F until the pivot 632R; 632F nests at the arresting recess 682R; 682F.

The arrangement is such that collapsing both the front wheel assembly 624 and the rear wheel assembly 626 takes place similar to the disclosure above, however with the front wheel assembly 624 configured for first encountering an elevated platform obstacle (not shown) for collapsing first as in the gradual steps illustrated in FIGS. 14C and 14D, and only after the front wheel assembly are at their fully collapsed position, and as the cart 620 continues to progress over the elevated surface, the rear wheel assembly 626 begins its collapsing as in FIGS. 14E to 14G. it is noted that at their collapsed position, both the front wheel assembly 624 and the rear wheel assembly 626 are disposed at a grasshopper-like configuration, namely extending upwards and rearwards substantially parallel to side walls of the payload basket 623.

Likewise, deploying the cart 620 into its fully deployed, extended position (i.e. riding position of FIGS. 14A and 14B) takes place in a reverse sequence, as discussed before, such that the rear wheel assembly 626 first deploys and only after complete deployment thereof, when it can bear loads, the front wheel assembly 624 begins to deploy into its fully extended.

1-17. (canceled)

18. A locomotion platform, comprising:
a front wheel assembly;
a rear wheel assembly; and
a payload module articulated to said locomotion platform;
wherein said locomotion platform is manipulable between a maneuverable riding position at which said front wheel assembly and said rear wheel assembly are deployed at an extended position, and a collapsed position at which the front wheel assembly and the rear wheel assembly are collapsed;
wherein the front wheel assembly and the rear wheel assembly are configured to be automatically unlocked from the extended position and automatically collapse upon encountering a barrier of a loading platform extending above ground;
wherein the front wheel assembly and the rear wheel assembly sequentially manipulate between the respective positions thereof.

19. The locomotion platform according to claim 18, wherein said front wheel assembly includes a uniform arm articulated to a break-link mechanism associated with a front activating mechanism, said break-link mechanism including a first link articulated at one end thereof to a base frame and pivotally linked to a second link which in turn is articulated at an end thereof to a wheel arm fitted at a bottom end with a caster, whereby the at an extended, the first link and the second link are geometrically locked at coextensive position.

20. The locomotion platform according to claim 19, wherein the first link is further configured with a lever articulated with the front activating mechanism, whereupon pivotal displacement of the activating mechanism entails corresponding pivotal displacement of the first link, resulting in collapsing of the link mechanism with corresponding swinging of the wheel arm into the collapsed position.

21. The locomotion platform according to claim 18, wherein:
said rear wheel assembly includes a parallel link mechanism including a wheel arm having a top arm link pivotally articulated at one end to the base frame of the locomotion platform and pivotally coupled at an opposed end thereof to a bottom arm link fitted at a bottom end thereof with a caster; and
a parallel link having a first end pivotally secured to the base frame and a second end pivotally articulated to a second arm link, below the pivoting point of the top arm link, wherein said parallel link remains parallely disposed with respect to the top arm link.

22. The locomotion platform according to claim 18, wherein the front wheel assembly and the rear wheel assembly are similar mechanisms.

23. The locomotion platform according to claim 18, wherein the arms of at least one of the front wheel assembly or the rear wheel assembly are configured with a height adjusting mechanism.

24. The locomotion platform according to claim 18, wherein, at the collapsed position, the front wheel assembly and the rear wheel assembly can be configured such that the front wheel assembly and the rear wheel assembly substantially do not project from the payload module of the cart.

25. The locomotion platform according to claim 18, wherein, at the collapsed position, the locomotion platform can be locomoted over the respective wheels of the front wheel assembly and the rear wheel assembly, as well as over encountering wheels.

26. A cart, comprising:
a locomotion platform including:
a front wheel assembly;
a rear wheel assembly; and
a payload module fixedly or detachably articulated to said locomotion platform;
wherein said locomotion platform is manipulable between a maneuverable riding position at which said front wheel assembly and said rear wheel assembly are deployed at an extended position, and a collapsed position at which the front wheel assembly and the rear wheel assembly are collapsed;
wherein the front wheel assembly and the rear wheel assembly are configured to be automatically unlocked from the extended position and automatically collapse upon encountering a barrier of a loading platform extending above ground;
wherein the front wheel assembly and the rear wheel assembly sequentially manipulate between the respective positions thereof.

27. The cart according to claim 26, wherein said front wheel assembly includes a uniform arm articulated to a break-link mechanism associated with a front activating mechanism, said break-link mechanism including a first link articulated at one end thereof to a base frame and pivotally linked to a second link which in turn is articulated at an end thereof to a wheel arm fitted at a bottom end with a caster, whereby the at an extended, the first link and the second link are geometrically locked at coextensive position.

28. The cart according to claim 27, wherein the first link is further configured with a lever articulated with the front activating mechanism, whereupon pivotal displacement of the activating mechanism entails corresponding pivotal displacement of the first link, resulting in collapsing of the link mechanism with corresponding swinging of the wheel arm into the collapsed position.

29. The cart according to claim 26, wherein said rear wheel assembly includes:
a parallel link mechanism including a wheel arm having a top arm link pivotally articulated at one end to the base frame of the locomotion platform and pivotally coupled at an opposed end thereof to a bottom arm link fitted at a bottom end thereof with a caster; and
a parallel link having a first end pivotally secured to the base frame and a second end pivotally articulated to a second arm link, below the pivoting point of the top arm link, wherein said parallel link remains parallely disposed with respect to the top arm link.

30. The cart according to claim 26, wherein the payload module is detachably attachable to a base frame of the locomotion platform.

31. The cart according to claim 26, wherein the payload module is configured with one or more landing wheels disposed at a front, bottom portion thereof, and configured for encountering an elevated loading surface, said payload module is detachable from the locomotion platform wherein the landing wheels facilitate for manually locomoting the detached payload module.

32. A front wheel assembly and a rear wheel assembly, for use in conjunction with a locomotion platform, at least one of the front wheel assembly and the rear wheel assembly is manipulable between a maneuverable riding position at which said front wheel assembly and rear wheel assembly are deployed at an extended position, and a collapsed position at which the front wheel assembly and the rear wheel assembly are collapsed, wherein the front wheel assembly and the rear wheel assembly are configured to be automatically unlocked from the extended position and automatically collapse upon encountering a barrier of a loading platform extending above ground, and wherein the front wheel assembly and the rear wheel assembly sequentially manipulate between the respective positions thereof.

33. The front wheel assembly and the rear wheel assembly according to claim 32, each including a pair of arms each disposed at a respective side of the locomotion platform and configured at a free end thereof with a caster; each of the arms of the front wheel assembly and the rear wheel assembly is manipulable between a riding position at which the arms are locked out at an extended position, and a collapsed position at which the arms are collapsed and retracted, disposed adjacent a rear edge of the locomotion platform; and wherein at the riding position the casters are substantially equi-leveled and configured for rolling over a surface.

34. The front wheel assembly and the rear wheel assembly according to claim 32, wherein said front wheel assembly includes a uniform arm articulated to a break-link mechanism associated with a front activating mechanism, said break-link mechanism including a first link articulated at one end thereof to a base frame and pivotally linked to a second link which in turn is articulated at an end thereof to a wheel arm fitted at a bottom end with a caster, whereby the at an extended, the first link and the second link are geometrically locked at coextensive position.

35. The front wheel assembly and the rear wheel assembly according to claim 34, wherein the rear activating mechanism includes an activating link pivotally articulated to the base frame and detachably arrested by a connecting link to the top arm link, whereupon pivotal manipulation of a free end of the activating link entails disengaging of the connecting link and corresponding pivotal displacement of the parallel link mechanism and simultaneous collapsing of a rear wheel arm, between a fully expanded, operative position, and a fully collapsed position.

36. The front wheel assembly and the rear wheel assembly according to claim 34, wherein the first link is further configured with a lever articulated with the front activating mechanism, whereupon pivotal displacement of the activating mechanism entails corresponding pivotal displacement of the first link, resulting in collapsing of the link mechanism with corresponding swinging of the wheel arm into the collapsed position.

37. The front wheel assembly and the rear wheel assembly according to claim 32, wherein said rear wheel assembly includes:
a parallel link mechanism including a wheel arm having a top arm link pivotally articulated at one end to the base frame of the locomotion platform and pivotally coupled at an opposed end thereof to a bottom arm link fitted at a bottom end thereof with a caster; and
a parallel link having a first end pivotally secured to the base frame and a second end pivotally articulated to a second arm link, below the pivoting point of the top arm link, wherein said parallel link remains parallely disposed with respect to the top arm link.

38. The front wheel assembly and the rear wheel assembly according to claim 32, wherein each of the front wheel assembly and the rear wheel assembly includes a collapse activating mechanism, wherein a respective one of the front wheel assembly or rear wheel assembly begins collapsing displacement thereof only upon said collapse activating mechanism encountering a barrier of a loading surface.
